(19) United States
(12) Patent Application Publication
(10) Pub. No.: US 2018/0213048 A1
(43) Pub. Date: Jul. 26, 2018

(54) SECURED TARGETING OF CROSS-APPLICATION PUSH NOTIFICATIONS

(71) Applicant: Microsoft Technology Licensing, LLC, Redmond, WA (US)

(72) Inventors: David J. Messner, Redmond, WA (US); Mohamed A. Aboubakr, Issaquah, WA (US); Laura S. Onu, Redmond, WA (US); Engy A. Ali, Bellevue, WA (US)

(21) Appl. No.: 15/697,936

(22) Filed: Sep. 7, 2017

Related U.S. Application Data
(60) Provisional application No. 62/449,444, filed on Jan. 23, 2017.

(51) Int. Cl. H04L 29/08; H04L 12/58; G06F 9/44

(52) U.S. Cl. CPC H04L 67/26; H04L 51/12; H04L 67/20; G06F 8/34; H04L 51/24

(57) ABSTRACT

Methods, systems, apparatuses, and computer program products are described herein for the development of applications and/or workflows that are enabled to transmit and/or push notifications to end-users. The developer (or “maker” or “creator”) of the application(s) and/or workflow(s) are enabled to develop such application(s) and/or workflow(s) without having to be expert programmers (i.e., such a developer may be a business user with little to no programming experience). The techniques described herein enable the transmission of cross-application push notifications to end-users of a target application in a secure manner. For example, push notification requests may be monitored to determine whether they are authorized to be transmitted in accordance with an administrator-configurable policy rule, thereby preventing unwanted push notifications from being transmitted. Moreover, computing resources may be scaled up (or scaled down) depending on how many users are to receive a particular push notification.

### BACKGROUND

Push technology describes a style of network-based communication where a request for a transmission of information is initiated by a publisher or a central server. In contrast, pull technology is where the request for the transmission of information is initiated by a receiver or client. Push services are often based on information preferences expressed in advance, which is often called a publish/subscribe model. In such a model, a client subscribes to various information channels. Whenever new content is available on one of those channels, the server pushes information out to the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer program products are described herein for the development of applications and/or workflows that are enabled to transmit and/or push notifications to end-users. The developer (which may also be referred to as a “maker” or “creator”) of the application(s) and/or workflow(s) are enabled to develop such application(s) and/or workflow(s) without having to be expert programmers (i.e., such a developer may be a business user with little to no programming experience). The techniques described herein enable the transmission of cross-application push notifications to end-users of a target application in a secure manner. For example, push notification requests may be monitored to determine whether they are authorized to be transmitted in accordance with an administrator-configurable policy rule, thereby preventing unwanted push notifications from being transmitted. Moreover, computing resources may be scaled up (or scaled down) depending on how many users are to receive a particular push notification. This advantageously enables systems described herein to meet the demand of transmitting a large number of push notifications in real time.

Further features and advantages of the invention, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 is a block diagram of an application development system, according to an example embodiment.

FIG. 2 shows a flowchart providing a process for development of workflows, according to an example embodiment.

FIG. 3 shows a block diagram of a application designer application, according to an example embodiment.

FIG. 4 shows a block diagram of a display screen showing a browser window displaying an exemplary workflow, according to an example embodiment.

FIGS. 5-8 shows views of an exemplary workflow in various phases of development using a development GUI, according to example embodiments.

FIGS. 9-11 shows views of a push connection creation process in various phases using a development GUI, according to example embodiments.

FIG. 12 shows an example GUI screen of an application development system that can be used to create a workflow that sends a push notification to one or more users of a target application whenever a record is created in a particular database, according to an example embodiment.

FIG. 13 depicts an example GUI screen in which a user specified a group of recipients, according to an example embodiment.

FIG. 14 is a block diagram of a system for executing a workflow that includes one or more workflow steps in a runtime environment, according to an example embodiment.

FIG. 15 shows a flowchart providing a process for executing workflow logic of a workflow, according to an example embodiment.

FIG. 16 shows a flowchart providing a process for generating and transmitting push notifications via a workflow application, according to an example embodiment.

FIGS. 17-20 show views of an administrative interface of a development GUI, according to example embodiments.

FIG. 21 shows a flowchart providing a process for transmitting push notifications in accordance with a policy rule, according to an example embodiment.

FIG. 22 shows a flowchart providing a process for denying a push notification request in accordance with a policy rule, according to an example embodiment.

FIG. 23 shows a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Business applications and consumer applications typically are created when available off-the-shelf software does not completely address the desired functionality. Many business and consumer applications are interactive, having a GUI into which users can input data, and which can be used to submit data queries, perform operations, and view results.

Users tend to depend on information technology (IT) personnel to code their applications due to application complexity and the programming expertise required. For instance, configuring an application to pull data from a source of interest to enterprises or consumers (e.g., data from an SQL (structured query language) database, customer relationship information from Salesforce.com of San Francisco, Calif., social network information from Facebook® operated by Facebook, Inc. of Palo Alto, Calif., or Twitter® operated by Twitter, Inc. of San Francisco, Calif.) is a difficult process.

Embodiments enable easier development of user applications and/or workflows, including business applications and consumer applications, that are enabled to transmit and/or push notifications to end-users. The developer (which may also be referred to as a “maker” or “creator”) of the application(s) and/or workflow(s) are enabled to develop such application(s) and/or workflow(s) without having to be expert programmers (i.e., such a developer may be a business user with little to no programming experience). The techniques described herein advantageously provide users with a flexible framework for sending notifications for tasks that are on the critical path of certain activities (e.g., business activities). The techniques described herein also enable the transmission of cross-application push notifications to end-users of a target application in a secure manner. For example, push notification requests may be monitored to determine whether they are authorized to be transmitted in accordance with an administrator-configurable policy rule, thereby preventing unwanted push notifications from being transmitted. Moreover, computing resources may be scaled up (or scaled down) depending on how many users are to receive a particular push notification. This advantageously enables systems described herein to meet the demand of transmitting a large number of push notifications in real time.

Example embodiments are described in the following sections for development of user application(s) and/or workflow(s) that are enabled to transmit/receive push notifications. In the following description, a person that develops a user application using the techniques described herein is referred to as a “developer,” which is to be distinguished from a person that uses the user application at runtime (a “user” or “end user”). It is noted, however, that a “developer,” as referred to herein, does not need to have expertise in computer programming. The embodiments described herein enable application development without special programming skills.

A. Example Application/Workflow Development Embodiments

Development of applications (e.g., business applications or workflow applications) may be enabled in various ways in embodiments. For instance, FIG. 1 shows an application development system 100, according to an example embodiment. As shown in FIG. 1, system 100 includes a computing device 102, storage 104, network-based application(s) 124 and a server 134. Server 134 includes an application designer 106 (e.g., in storage). Application designer 106 includes a UI generator 110. Computing device 102 includes a display screen 108 and a browser 136. Storage 104 stores a local application 122. System 100 is described as follows.

Computing device 102 may be any type of stationary or mobile computing device, including a mobile computer or mobile computing device (e.g., a Microsoft® Surface® device, a laptop computer, a notebook computer, a tablet computer such as an Apple iPad™, a netbook, etc.), a wearable computing device (e.g., a head-mounted device including smart glasses such as Google® Glass™, etc.), or a stationary computing device such as a desktop computer or PC (personal computer). Server 134 may include one or more server devices and/or other computing devices.

Local application 122 in storage 104 is an example of an application accessible by computing device 102 without communicating over a network. Local application 122 may be configured to perform data processing and/or data hosting operations when executed by a processor of computing device 102, and may provide data 132 to applications created by application designer 106 during runtime of those applications. Local application 122 may be any type of local application/service, such as a database application (e.g., QuickBooks®, a Microsoft® Excel® spreadsheet), a messaging application (e.g., Microsoft® Outlook®), a productivity application (e.g., Microsoft® Word®, Microsoft® PowerPoint®, etc.), or another type of application. Although FIG. 1 shows a single local application, any number of local applications may be present at computing device 102, including numbers in the tens, hundreds, or greater numbers.

Network-based application(s) 124 are examples of network-based applications, also referred to as “cloud” applications or services. Network-based application(s) 124 are accessible by computing device 102 over network(s) 126, may be configured to perform data processing and/or data hosting operations, and may provide data 130 to applications created by application designer 106 during runtime of those applications. Network-based application(s) 124 may each be any type of web accessible applications/services, such as database applications, social networking applications, messaging applications and/or services, financial services applications, news applications, search applications, web-accessible productivity applications, cloud storage and/file hosting applications, etc. Examples of such applications include a web-accessible SQL (structured query language) database, Salesforce.com™, Facebook®, Twitter®, Instagram®, Yammer®, LinkedIn®, Yahoo!® Finance, The New York Times® (at www.nytimes.com), Google search, Microsoft® Bing, Google Docs™, Microsoft® Office 365, Dropbox™, etc. Network-based application(s) 124 may include any number of network-based applications, including numbers in the tens, hundreds, thousands, or greater numbers.

Note that data 130 and data 132 may each include any type of data, including messages, notifications, calculated data, retrieved data, and/or any other type of information requested or usable by an application.

Computing device 102 and server 134 may each include at least one network interface that enables communications with each other and with network-based application(s) 124 over network(s) 126. Examples of such a network interface, wired or wireless, include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein. Examples of network(s) 126 include a local area network (LAN), a wide area network (WAN), a personal area network (PAN), and/or a combination of communication networks, such as the Internet.

Application designer 106 is configured to be operated/interacted with to create applications (e.g., business application(s), workflow application(s), etc.). For instance, a developer may access application designer 106 by interacting with an application at computing device 102 capable of accessing a network-based application, such as browser 136. The developer may use browser 136 to traverse a network address (e.g., a uniform resource locator) to application designer 106, which invokes an application designer GUI 116 (e.g., a web page) in a browser window 114. The developer is enabled to interact with application designer GUI 116 to develop an application.

As shown in FIG. 1, application designer 106 includes UI generator 110 and application logic generator 112. UI generator 110 is configured to transmit application GUI information 140 (e.g., one or more web pages, image content, etc.) to browser 136 to be displayed as application designer GUI 116 in display screen 108 in browser window 114. Application designer GUI 116 may be interacted with by the developer to select and configure various application interface elements (e.g., buttons, menus, text boxes, etc.) into a business application or workflow steps into a workflow.

For example, the developer may insert and sequence a plurality of workflow steps in application designer GUI 116, with one or more of the steps being associated with a local or network-based application. The developer may further insert and sequence one or more workflow steps that enable the application being developed to send a message to one or more users of one or more other applications (i.e., target applications). The target application(s) may be the same type of application as the application that transmits the push notification (i.e., a source application). Alternatively, the target application(s) may be a different type of application than the source application (e.g., the target application(s) are not other instance(s) of the source application). The message may be an e-mail, a Short Message Service (SMS) message, a push notification and/or the like. Such step(s) may use a connector that is associated with a certain application or service (e.g., a push notification service, such as, but not limited to Azure Notification Hubs from Microsoft Corporation®) to send notifications to any users who have permission to receive such notifications via target application(s). As used herein, the term “connector” generally refers to a programming interface (e.g., an application programming interface (API)) that invokes an application or service for communication with the application being developed. When developing an application that is to invoke such an application or service, a developer may create a connection that is associated with (e.g., uses) a connector. A developer may specify one or more properties of the connection that are specific to the application being developed (i.e., the developer creates an instance of a connection that has been customized for use with the application being developed). Additional details regarding connection creation are described below in Subsection B.

In an example in which a workflow application is being developed, browser 136 stores the selected workflow steps, corresponding configuration information, and workflow step sequence information as constructed workflow information 138. Constructed workflow information 138 is transmitted to application logic generator 112 at server 134. Application logic generator 112 generates workflow logic 120 based on the assembled workflow represented by constructed workflow information 138. The workflow represented by workflow logic 120 may subsequently be invoked at runtime by an end user.

During runtime of the workflow, workflow logic 120 may invoke operation of one or more local or network-based applications associated with the workflow steps of workflow logic 120. In an example in which a workflow step is configured to transmit a push notification, workflow logic 120 may invoke operation of a network-based application, such as push notification service that enables push notifications to be transmitted from the application being developed and a target application. For example, one of network-based application(s) 124 may be a push notification service, such as Azure Notification Hubs from Microsoft Corporation®. Each workflow step may receive input data from application designer GUI 116, data 132 from local application 122, data 130 from network-based application(s) 124, and/or data from another workflow step of workflow logic 120.

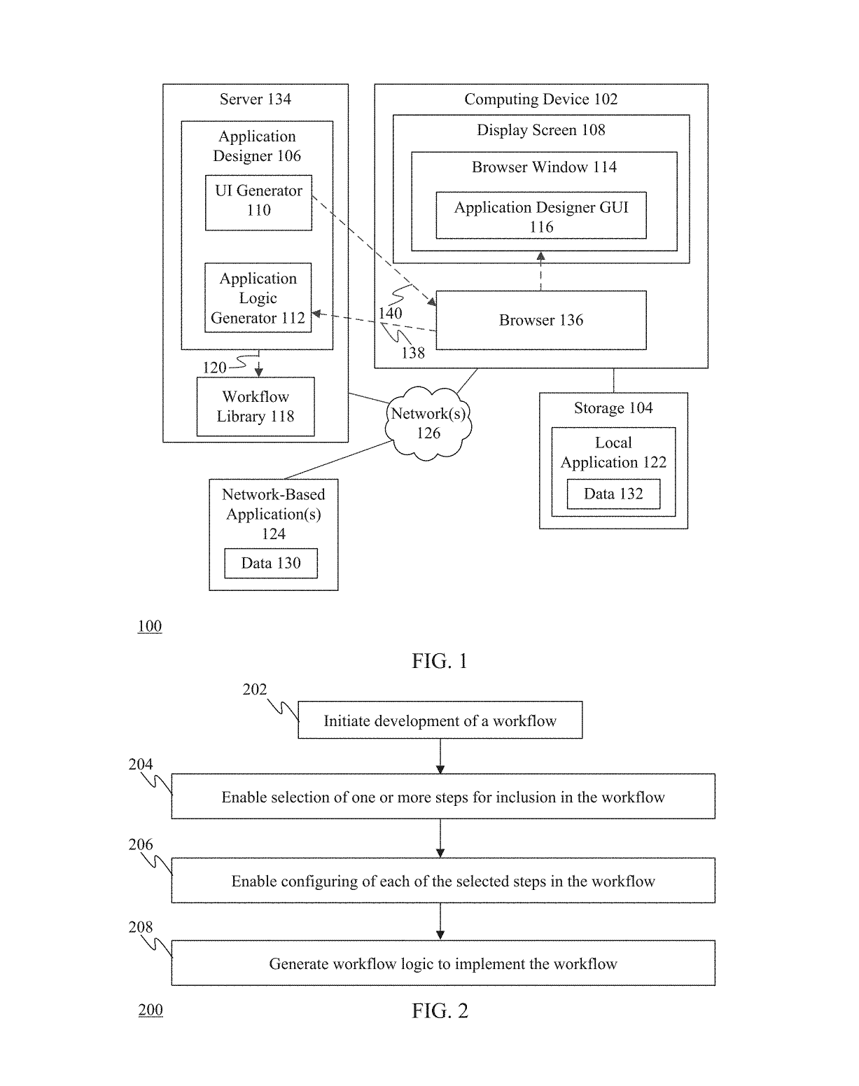

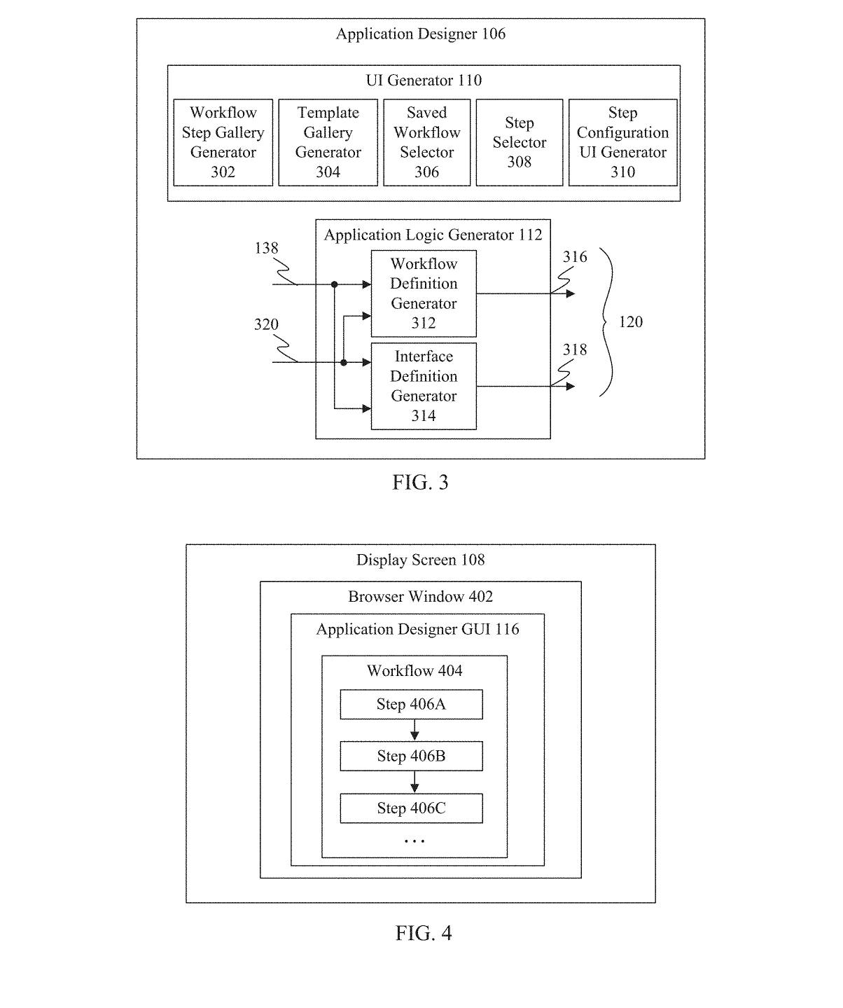

Application designer 106 may operate in various ways, to enable development of an application or a workflow. For instance, in embodiments, application designer 106 may operate according to FIG. 2. FIG. 2 shows a flowchart 200 providing a process for development of workflows, according to an example embodiment. Flowchart 200 and application designer 106 are described as follows with respect to FIGS. 3 and 4. FIG. 3 shows a block diagram of application designer 106, according to an example embodiment. As shown in FIG. 3, application designer 106 includes UI generator 110 and application logic generator 112. UI generator 110 includes a workflow step gallery generator 302, a template gallery generator 304, a saved workflow selector 306, a step selector 308, and a step configuration UI generator 310. Application logic generator 112 includes a workflow definition generator 312 and an interface definition generator 314. FIG. 4 shows a block diagram of display screen 108, illustrating an example of application designer GUI 116 displayed in browser window 402 on display screen 108, according to an example embodiment

Flowchart 200 of FIG. 2 begins with step 202. In step 202, development of a workflow is initiated. For example, in an embodiment, application designer 106 may be invoked by a developer interacting with browser 136 at computing device 102. The developer may traverse a link or other network address directed to application designer 106 at server 134, to invoke application designer 106, causing application designer 106 to provide application GUI information 140 (e.g., one or more web pages, image content, etc.) to browser 136 to be displayed as application designer GUI 116 in display screen 108 in browser window 114. Once invoked, the developer may open an existing workflow for further development, or may begin a new workflow.

For instance, a displayed page of application designer GUI 116 may display a gallery or workflow steps generated by workflow step gallery generator 302. The workflow step gallery includes a plurality of selectable workflow steps. The workflow steps may be stored in workflow library 118, and accessed for display by application designer GUI 116. The developer may select one of the workflow steps for inclusion in their workflow, and may proceed with configuring the contents of the workflow step, and/or may add additional workflow steps to continue generating their workflow.

For example, as shown in FIG. 4, workflow step gallery generator 302 may enable steps 406A, 406B, and 406C to be selected for insertion into a workflow 404 being assembled in application designer GUI 116. Any number of workflow steps may be inserted.

In another example, a displayed page of application designer GUI 116 may display a template gallery generated by template gallery generator 304. The template gallery includes a plurality of selectable workflow templates, which each include one or more workflow steps pre-connected for operation. The workflow templates may be stored in workflow library 118, and accessed for display by application designer GUI 116. The developer may select one of the workflow templates for inclusion in their workflow, and may proceed with configuring the contents of the workflow template, and/or may add additional workflow steps to the workflow steps of the workflow template to generate a more complex workflow.

For instance, in the example of FIG. 4, steps 406A and 406B may have been included in a workflow template placed in workflow 404, step 406C may have been subsequently added (e.g., from a workflow step gallery).

In another example, saved workflow selector 306 may enable the developer to select an existing, saved workflow to be opened for further editing in a displayed page of application designer GUI 116. The saved workflows may be stored in workflow library 118 or elsewhere. For example, saved workflow selector 306 may display a list of saved workflows, may enable navigation to a saved workflow, and/or may provide another mechanism for selecting a saved workflow for editing. The developer may then proceed with further configuring the contents of the workflow, and/or may add additional workflow steps to the workflow steps of the workflow to generate a more complex workflow.

In step 204, selection of one or more steps for inclusion in the workflow is enabled. When a developer is editing a workflow, step selector 308 may enable the developer to select further workflow steps for inclusion in the workflow, and to order the steps. The workflow steps may be accessed by step selector 308 in workflow library 118. For instance, step selector 308 may display a pull-down menu of workflow steps, a scrollable and/or searchable list of available workflow steps, or may provide the workflow steps in another manner, and may enable the developer to select any number of workflow steps from the list for inclusion in the workflow.

In one example, step selector 308 may enable a developer to select a step that is associated with a local application, such as Microsoft® Outlook®, or a network-based application, such as Facebook®. In another example, step selector 308 may enable a developer to select a step that is associated with a network-based application 124, such as a push notification service used to transmit push notifications. Step selector 308 enables the steps to be chained together in a sequence, optionally with conditional steps, for inclusion in workflow logic 120.

In step 206, each of the selected steps in the workflow is enabled to be configured. In an embodiment, step configuration UI generator 310 enables configuration of each workflow step in a workflow. Step configuration UI generator 310 accesses each selected workflow step in workflow library 118 to determine the configuration of the workflow step, including all of its input parameters and any other selections or information that a user or developer needs to provide to the workflow step to configure it For example, step configuration UI generator 310 may generate a UI that enables the developer to type, navigate to, use a pull-down menu, or otherwise enter input data into a text input box or other data input element (e.g., input parameter) of a workflow step. The developer may configure an output of a prior step to be input data for a workflow step. Step configuration UI generator 310 may enable data or other objects to be copied and pasted, dragged and dropped, or otherwise entered copied from elsewhere into data input boxes of a workflow step.

In step 208, workflow logic to implement the workflow is generated. In an embodiment, application logic generator 112 is configured to package and generate workflow logic 120 based on constructed workflow information 138 when the developer indicates the workflow is finished, such as when the developer interacts with application designer GUI 116 to save the workflow. As shown in FIG. 3, application logic generator 112 receives constructed workflow information 138. Constructed workflow information 138 indicates which workflow steps have been inserted into the workflow, their input parameter values, and their sequencing. Application logic generator 112 also receives selected workflow logic 320, which is the workflow logic for each workflow step of the workflow as indicated in constructed workflow information 138. In one example, application logic generator 112 retrieves workflow logic from workflow library 118 for each workflow step indicated in constructed workflow information 138, to receive selected workflow logic 320. Application logic generator 112 generates workflow logic 120 for the workflow based on constructed workflow information 138 and selected workflow logic 320. For example, application logic generator 112 may generate workflow logic 120 in the form of an executable file, a zip file, or other form, which may be executed in a standalone fashion, may be executed in a browser, or may be executed in another manner, depending on the particular type of workflow being generated.

With reference to FIG. 3, application logic generator 112 may generate workflow logic 120 to include at least two components (e.g., files): workflow definition information 316 and interface definition information 318. Workflow definition information 316 includes information that defines the sequence and operation of the workflow of workflow logic (e.g., lists the workflow step operations and their ordering/sequencing) and includes the parameter values for the workflow. For example, workflow definition information 316 may be generated to contain information in the format of a JSON (JavaScript object notation) file or in another form. Interface definition information 318 includes information that defines the interfaces/parameters (e.g., inputs and outputs) of the workflow steps of the workflow. For example, interface definition information 318 may be generated to contain information in the OpenAPI format (which is a specification for REST (representational state transfer) web services) or in another form. For instance, each workflow step may be represented in workflow library 118 as API (application programming interface) metadata in the OpenAPI format, defining what are the necessary inputs and outputs (parameters) of the workflow step, such that a service may be accessed according to the API definition. In such an implementation, the operations in the workflow definition information 316 refer to the corresponding API metadata in the interface definition information 318 to give a complete structure of a generated workflow (e.g., each sequenced workflow step/operation defined with parameter values in the workflow definition information 316 has a corresponding API, which is defined in the interface definition information 318).

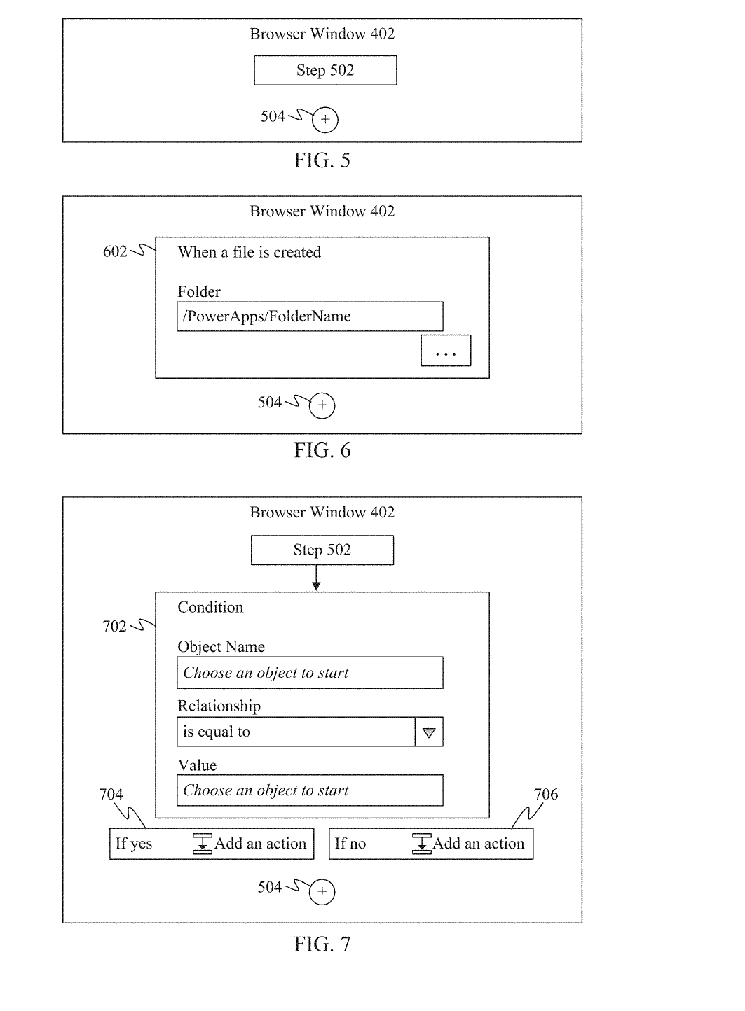

Accordingly, flowchart 200 and application designer 106 enable a developer to create workflows. FIGS. 5-8 shows views of an exemplary workflow in various phases of development using a development GUI, according to example embodiments. For example, each of FIGS. 5-8 show browser window 402 displaying a corresponding view of application designer GUI 116 being used to develop a workflow.

For instance, FIG. 5 shows browser window 402 including a workflow step 502 and an add interface 504. Workflow step 502 was selected by a developer to be a first step in a workflow. Add interface 504 (e.g., a button or other GUI control) may be interacted with by the developer to add further workflow steps to the workflow.

As described above, a developer is enabled to select workflow step 502 from a list or library of steps, a gallery of workflow steps, a template gallery, or elsewhere. A list, library, or gallery may include any number of workflow steps. The workflow steps may be associated with network-based applications mentioned elsewhere herein or otherwise known (e.g., Dropbox™, Azure Notification Hubs from Microsoft Corporation®, etc.), and/or with local applications mentioned elsewhere herein or otherwise known (e.g., Microsoft® Outlook®). Each workflow step is configured for plug-and-place into the workflow. Each workflow step is configured with the appropriate logic and/or interface(s) to perform its respective function(s), which may include communicating with a local or remote application. For instance, a workflow step may be configured to transmit a query to an application (e.g., a search query to a search engine, a database query to a database, a request for data from a social networking application, etc.), being pre-configured how to properly transmit and format such a request to the application. The workflow step may be configured to receive a response to the request, being pre-configured how to parse the response for desired response data. As such, a developer of a workflow does not need to know how to write program code in a programming language, to interface with complex application interfaces (e.g., application programming interfaces (APIs)), or to understand network communication protocols, as the workflow steps are already setup. When a workflow step is plugged into workflow logic by a developer, the developer configures the inputs to the workflow step (as described below), and the otherwise pre-configured workflow step handles any communications with other applications.

In FIG. 6, the developer has interacted with step 502 (e.g., by mouse click, etc.) to cause step configuration UI generator 310 to generate a UI for configuration of step 502. For instance, in the example of FIG. 6, workflow step 502 is configured to monitor for a file to be created in a particular folder identified by the developer in a text input box (e.g., by typing, clicking on a navigator indicated by “ . . . ”, etc.). When workflow step 502 determines a file is added to the indicated folder, a workflow step following workflow step 502 is triggered. Thus, workflow step 502 may be considered a trigger step in this example.

For instance, in FIG. 7, the developer interacted with add interface 504 to select a next workflow step 702. In an embodiment, interaction with add interface 504 invokes step selector 308 in FIG. 3, which enables the developer to select a workflow step. In the example of FIG. 7, workflow step 702 is a conditional step. In embodiments, logical elements may be selected for inclusion in a workflow, including arithmetic logic (e.g., summers, multipliers, etc.), conditional logic, etc., that operate based on variable values determined in earlier workflow steps. The condition of workflow step 702 enables the workflow to fork based on the determination of a condition (e.g., a variable value). The condition may include an object name, a relationship (e.g., a logical relationship, such as equal to, includes, not equal to, less than, greater than, etc.), and a value, which are all defined by the developer interacting with workflow step 702. Corresponding action steps may be performed depending on which way the workflow forks based on the condition.

In one illustrative example of FIG. 7, the object name may be selected (e.g., from a list of possibilities) to be a name of the created file of workflow step 502, the relationship may be “contains” (e.g., selected by a pull-down menu) and the value may be “dummyfile” (e.g., typed in by the developer). The condition evaluates to a “yes” condition if the file name contains “dummyfile,” which invokes first action workflow step 704, and evaluates to “no” condition if the file name does not contain “dummyfile,” which invokes second action workflow step 706. An action may be defined for one or both of the “yes” and “no” action workflow steps 704 and 706 by the developer, if desired.

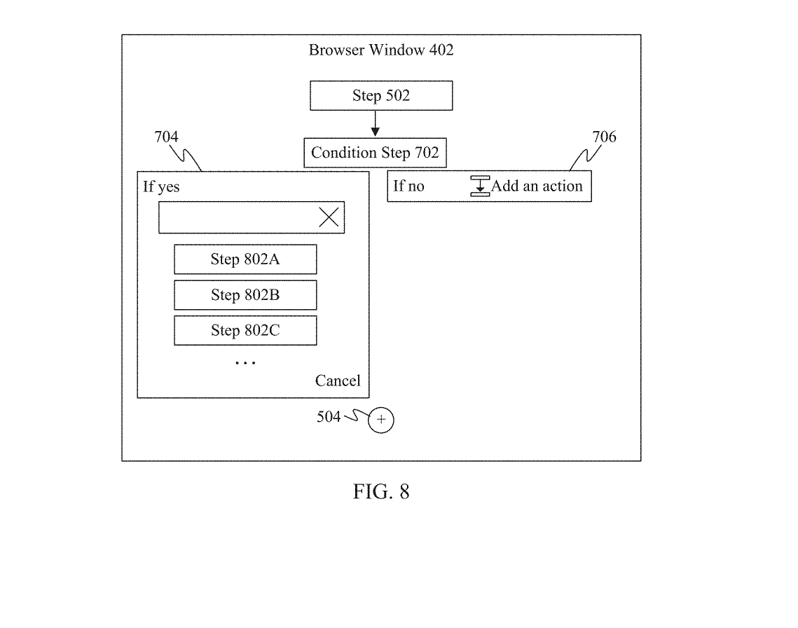

For example, in FIG. 8, the developer interacts with action workflow step 704 to define an action. In this example, the developer is defining action workflow step 704 by selecting a workflow step via step selector 308. As shown in FIG. 8, a list of workflow steps 802A, 802B, 802C is displayed, from which the developer can select a workflow step (e.g., by mouse click, etc.) to be performed for action workflow step 704. The workflow step can be a trigger step, an action step, or a condition step. After selecting the workflow step, the developer may configure the workflow step as described above. Furthermore, the developer may configure an action for workflow step 706, may add further workflow steps, etc., eventually being enabled to save the workflow.

It is noted that in some embodiments, a workflow step, such as first workflow step 502, may require credentials (e.g., a login and password) to access indicated data (e.g., to access a file at the location indicated in the text input box in FIG. 6). As such, the developer may be requested to provide credential information in association with first workflow step 502 so that when first workflow step 502 is performed during runtime, the data may be accessed. Alternatively, the credentials may be requested of a user during runtime.

B. Example Connection Creation Embodiments

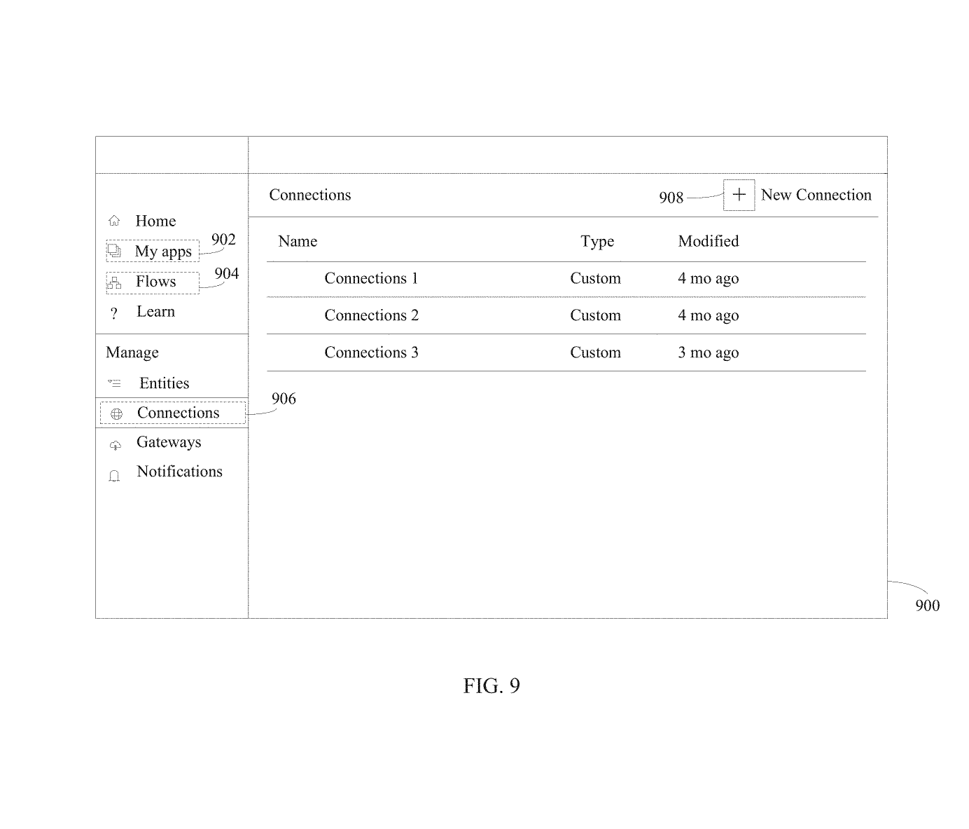

A developer may be able to create one or more connections that can be implemented in application(s) being developed by the developer and/or other developer(s). As described above, the connection(s) enable the application being developed to invoke another application or service using an associated connector. In the example described below, a connection is created to generate a push notification connection. The connection is customized by specifying the target application that is to receive push notifications. For example, FIGS. 9-11 show views of a GUI (e.g. application designer GUI 116) for creating a push notification connection in accordance with an embodiment.

For instance, FIG. 9 shows a GUI screen 900 of application designer GUI 116 in accordance with an embodiment. As shown in FIG. 9, GUI screen 900 includes a plurality of user-activatable interface elements, including, but not limited to, a user interface element 902, user interface element 904, user interface element 906, and user interface element 908. User interface element 902 (“My apps”), when activated by a user, may cause a GUI screen to be displayed that shows a listing of applications developed by the user. User interface element 904 (“Flows”), when activated by a user, may cause a GUI screen to be displayed that shows a listing of workflows developed by the user. User interface 906 (“Connections”), when activated by a user, may cause a GUI screen to be displayed that shows a listing of connections created by the user. As shown in FIG. 9, user interface 906 has been activated by the user, thus a listing of connections (i.e., “Connection 1,” “Connection 2,” and “Connection 3”) created by the user has shown. As also shown in FIG. 9, a user interface element 908 (“New connection”) is also displayed. A user may activate user interface element 908 (“New connection”) to initiate the connection creation process.

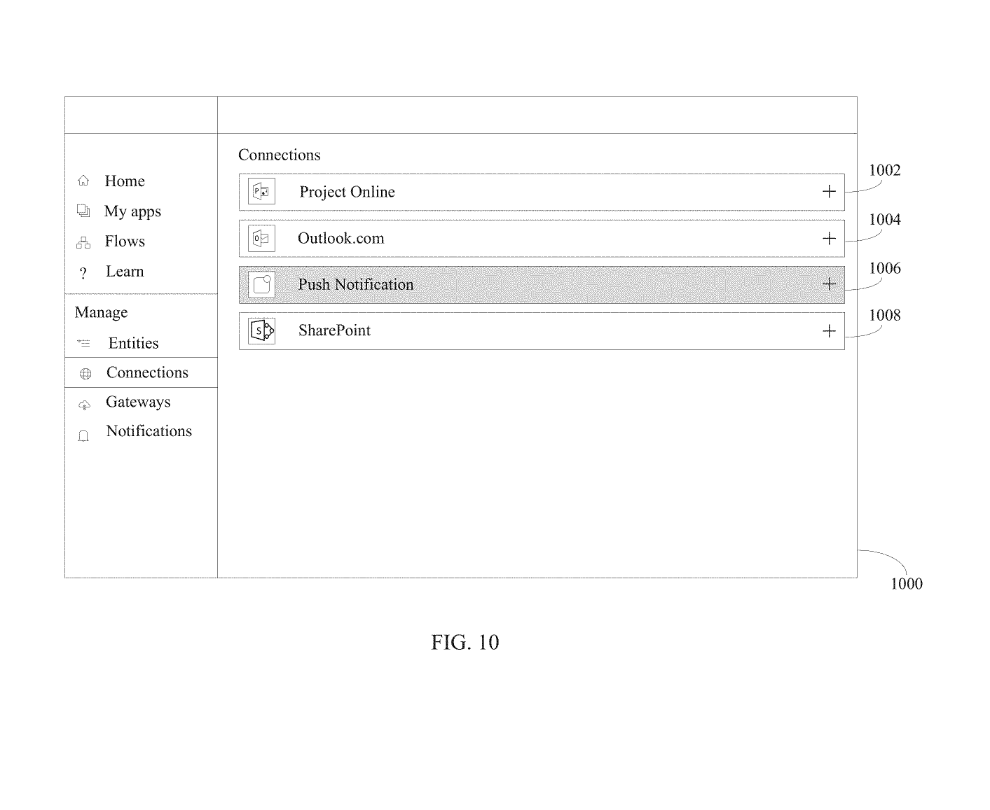

For instance, FIG. 10 shows a GUI screen 1000, which is displayed responsive to a user activating user interface 908 in accordance with an embodiment. As shown in FIG. 10, responsive to a user activating user interface element 908, a list of user-selectable connection identifiers 1002, 1004, 1006 and 1008 that each identify a particular type of connection are displayed. For instance, connection identifier 1002 identifies a first connection type associated with a first software application (e.g., “Project Online”), connection identifier 1004 identifies a second connection type associated with a second software application (e.g., “Outlook.com”), connection identifier 1006 identifies a third connection type associated with a first service (e.g., a push notification service labeled as “Push Notification”), and connection identifier 1008 identifies a fourth connection type associated with a third software application (e.g., “SharePoint”). Upon selecting one of connection identifiers 1002, 1004, 1006 or 1008, a GUI screen is displayed that enables the user to create a connection for the selected connection type. As shown in FIG. 10, a user has selected the Push Notification connection type.

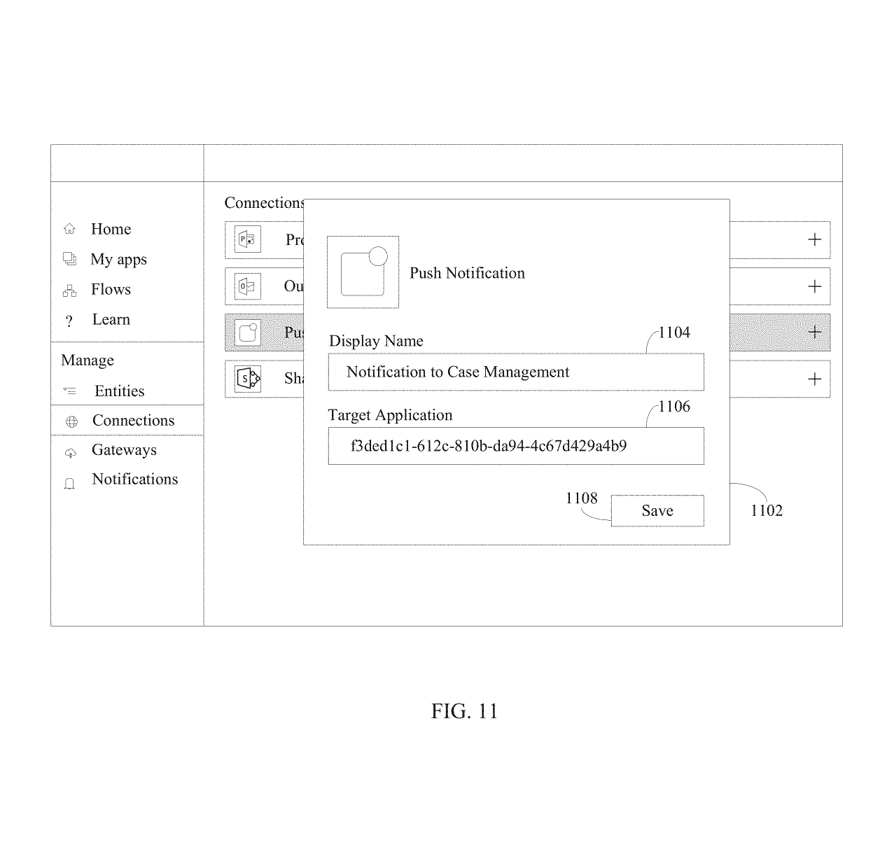

FIG. 11 shows a GUI screen 1100, which is displayed responsive to a user activating connection identifier 1006 in accordance with an embodiment. As shown in FIG. 11, upon selecting the connection identifier 1006, the user is presented with a window 1102 that enables the user to specify certain parameters of the push notification connection being created. For example, as shown in FIG. 11, window 1102 includes a user interactive field 1104 and a user interactive field 1106. User interactive field 1104 may enable the user to specify the name of the connection being created, and user interactive field 1106 may enable the user to specify the target application that is to receive push notifications via the push notification connection being created. The target application may be a different type of application than the source application in which the connection is incorporated. As shown in FIG. 11, the user has specified the name of the connection to be “Notification to Case Management.” The target applications may be specified using a unique ID, an application name, etc. As shown in FIG. 11, the user has specified the target application via a unique ID (i.e., “f3ded1c1-612c-810b-da94-4c67d429a4b9”). After the user specifies the parameters, the user may save the connection by activating a user interface element 1108 “Save”.

C. Example Push Notification-Enabled Application/Workflow Development Embodiments

Once a connection is created, a developer may be enabled to incorporate it in an application that he or she is developing. For example, a developer may create a workflow application that includes a workflow step associated with a push notification connection in accordance with an embodiment, thereby enabling the workflow to transmit push notifications to other applications.

Such steps can also be combined with other workflow steps that are designed to interact with other applications (e.g., email applications, document management applications, database applications, social networking applications, financial services applications, news applications, search applications, productivity applications, cloud storage applications, file hosting applications, etc.).

As was previously described, application designer 106 generates workflow application GUI 116 that enables a developer to configure a workflow step within a workflow under development, wherein such configuration includes specifying a value of an input parameter for the workflow step. In an embodiment, application designer GUI 116 enables a developer to easily specify a value of an input parameter of a second workflow step to include a value of an output parameter of a first workflow step in the same workflow.

In particular, in accordance with an embodiment, application designer GUI 116 represents output parameters of a first workflow step of a workflow under development as user-interactive objects. These objects can be easily interacted with (e.g., clicked on or dragged and dropped) by a developer to cause the objects to be inserted into a data entry element (e.g. a text box) that is used to specify a value for an input parameter of a second workflow step of the workflow under development. When executable logic representing the first and second workflow steps is generated, the aforementioned insertion of the objects into the data entry element has the effect of causing the value of the input parameter of the second workflow step to be defined to include the values of the output parameters that correspond to the inserted objects.

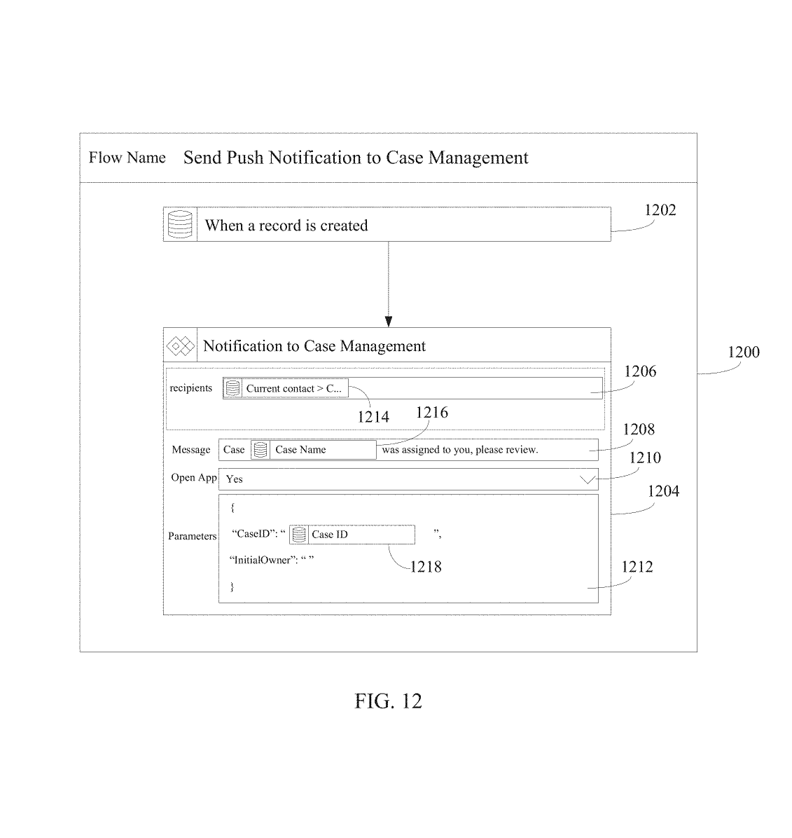

To help illustrate some of the foregoing concepts, FIG. 12 depicts an example GUI screen 1200 of an application development system that can be used to create a workflow that sends a push notification to one or more users of a target application whenever a record is created in a particular database in accordance with an embodiment. GUI screen 1200 may be generated, for example, by UI generator 110 of application designer 106 as previously described in reference to workflow development system 100 of FIG. 1.

In particular, as shown in FIG. 12, the workflow includes a first workflow step 1202, entitled “When a record is created” and a second workflow step 1204 entitled “Notification to Case Management”. Second workflow step 1204 implements the “Notification to Case Management” connection described above in Subsection B. Each of first workflow step 1202 and second workflow step 1204 may be configured to receive one or more user-customizable parameters that may be manually customized by the user. First workflow step 1202 may be referred as a trigger step because it is activated at runtime by the occurrence of a triggering event. In this case, first workflow step 1202 is activated whenever a record is added to a specified database.

Second workflow step 502 may be referred to as an action step because it causes an action to be performed at runtime in response to the execution of the trigger step. In this case, the action in second workflow step 1204 is transmitting a push notification when a record is created in a specified database (e.g., a database specified via workflow step 502). The push notification may be transmitted via the “Notification to Case Management” connection. As shown in FIG. 12, second workflow step 1204 includes a data entry box 1206, a data entry box 1208, a pull-down menu 1210, and a data entry box 1212. Data entry box 1206 is configured to receive one or more user-customizable parameters that represent one or more recipients of the push notification to be transmitted. Such parameter(s) include, but are not limited to, an email-address, a phone number, etc. As shown in FIG. 12, a user-interactive object 1214 is provided as an input parameter in data entry box 1206. User-interactive object 1214 represents the recipient of the push notification for the new case that is generated as a result of a record being created in the specified database (e.g., a database specified in workflow step 102).

Data entry box 1208 is configured to receive a user-customizable parameter that represents the message to be transmitted via the push notification. As shown in FIG. 12, a user-interactive object 1216 is provided as an input parameter in data entry box 1208, along with user-specified text. User-interactive object 1216 represents the case name of the case that is created as a result of a record being created in the specified database.

Pull-down menu 1210 enables a user to indicate whether the targeted application (i.e., the application to receive the push notification) is to be launched when a notification is received. In the example shown in FIG. 12, the developer has selected the “Yes” option, which causes the target application to be launched upon receiving the push notification. In another example, the developer may select a “No” option, which causes the push notification to be displayed via the recipient's device (e.g., a mobile smart phone) without launching the target application. It is noted that a developer may also be enabled to specify how the target application is supposed to behave upon receiving the notification. For example, the developer may specify a parameter that indicates that the target application is to traverse to a particular GUI screen thereof.

Data entry box 1212 is configured to receive one or more additional user-customizable parameters, such as, but not limited to an ID number of the newly-created case and/or owners of the case. As shown in FIG. 12, a user-interactive object 1218 is provided as an input parameter in data entry box 1212. User-interactive object 1218 represents the case ID of the case that is created as a result of a record being created in the specified database.

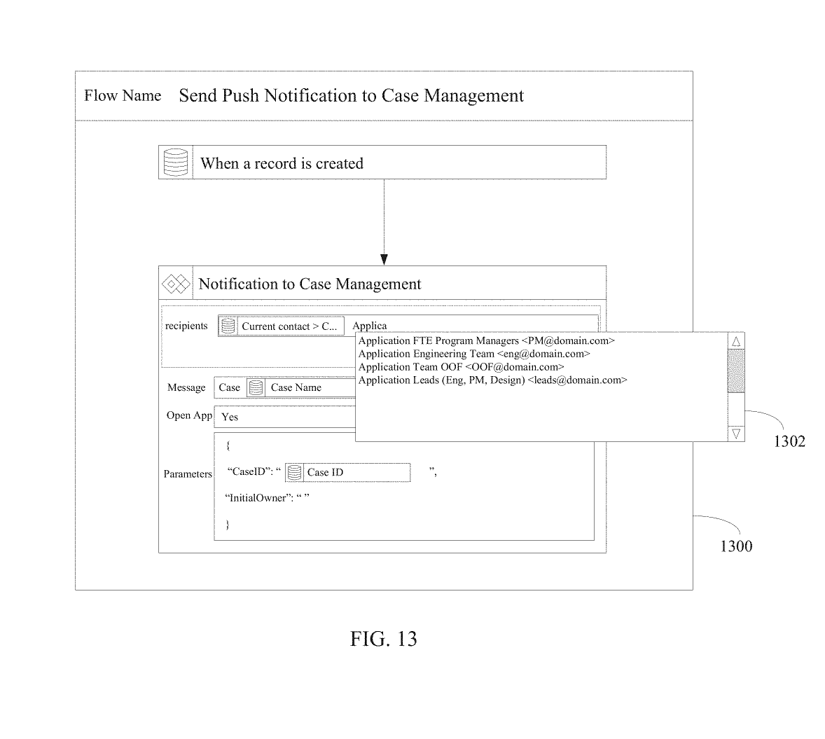

In accordance with an embodiment, a developer may specify a group of recipients in addition to or in lieu of a single recipient. For example, FIG. 13 depicts an example GUI screen 1300 in which a user specified a group of recipients in accordance with an embodiment. As shown in FIG. 13, a user may begin entering in a group identifier (e.g., a group email address or a string of characters representative thereof). In response, application designer GUI 106 returns group identifiers matching the entered in group identifier via a scroll box 1302. The developer may select the desired group identifier displayed via scroll box 1302. As will be described in subsection D below, during execution of the workflow, the group identifier may be expanded into a plurality of individual user identifiers via a directory service. The user identifiers may be used to individually transmit push notifications to the corresponding user.

D. Example Push Notification-Enabled Application/Workflow Execution Embodiments

According to embodiments, end users may execute applications developed as described herein. In an example in which a workflow is being executed, during operation, an end user may interact with a GUI of the workflow, which may lead to workflow logic being executed. The workflow logic may execute locally (e.g., in a browser) and/or at a remote service (in “the cloud”). The workflow logic may transmit data to or receive data from of one or more local or network-accessible applications (e.g., a push notification service). Accordingly, the workflow performs its intended functions.

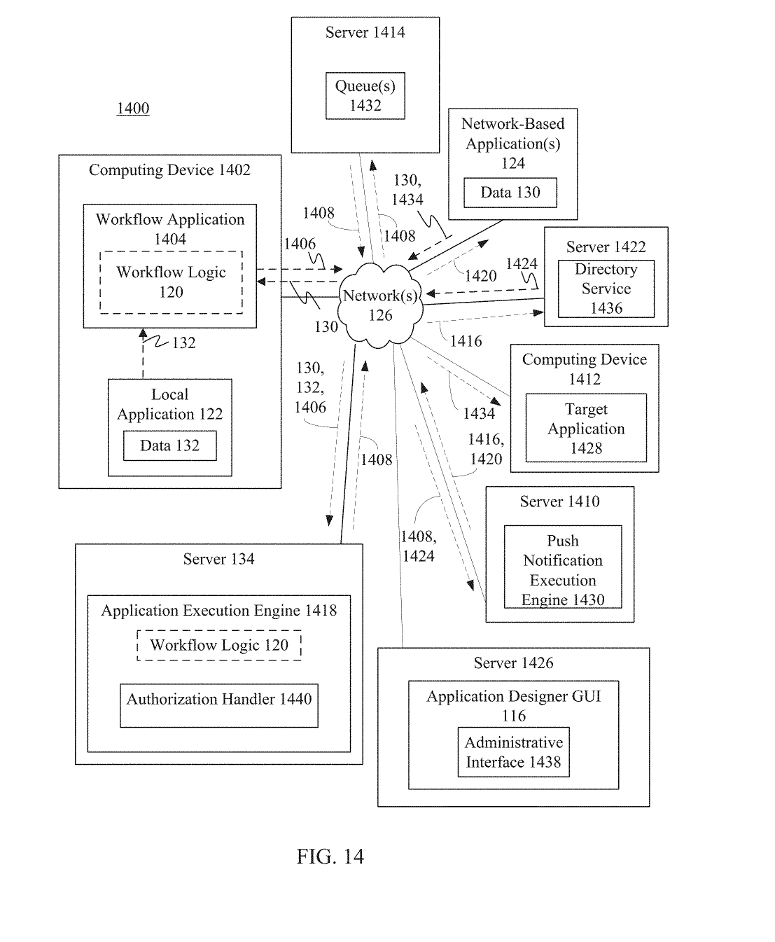

FIG. 14 is a block diagram of a system 1400 for executing a workflow that includes one or more workflow steps in a runtime environment, according to an example embodiment. As shown in FIG. 14, system 1400 includes a computing device 1402, network-based application(s) 124, server 134, a server 1410, a server 1414, a server 1422, a server 1426 and a computing device 1412. Computing device 1402 includes a workflow application 1404. Server 134 includes an application execution engine 1418. Server 1410 includes a push notification execution engine 1430. Server 1422 includes a directory service 1436. Server 1414 includes one or more queue(s) 1432. Server 1426 may be configured to execute an administrative interface 1438 via application designer GUI 116. Computing device 1412 includes a target application 1428 configured to receive push notifications. System 1400 is described as follows.

Network-based applications(s) 124 may be optionally present, and whether or not such entities are communicated with will depend on the configuration of workflow logic 120. Further network-based applications and services may be present and communicated with, depending on the configuration of workflow logic 120.

Computing device 1402 and/or computing device 1412 may be any type of stationary or mobile computing device described herein or otherwise known. Each of computing device 1402, computing device 1412, server 134, network-based application(s) 124, server 1410, server 1414, server 1422 and/or server 1426 is configured to communicate with each other over network(s) 126 (e.g., in a “cloud-based” embodiment).

In one embodiment, workflows are executed at server 134 by application execution engine 1418, and workflow application 1404 is a UI application that enables an end user at computing device 1402 to interact with the executing workflows, such as by selecting and invoking the workflows, receiving communications from the executing workflows (e.g., messages, alerts, output data, etc.), providing requested input data to executing workflows, etc. In such an embodiment, workflow application 1404 may be an application UI application associated with application execution engine 1418 (e.g., workflow application 1404 may be an extension of application execution engine 1418) that may operate separately from or within a browser at computing device 1402, or may be configured in another way. As shown in FIG. 14, application execution engine 1418 may receive and load workflow logic 120 for a selected workflow application (e.g., selected from a workflow library by a user), and may execute workflow logic 120 to execute the workflow application.

In another embodiment, workflow application 1404 may be configured to execute workflows at computing device 1402. For instance, an end user of computing device 1402 may interact with a user interface of application 1404 to select and invoke a particular workflow (e.g., selected from a workflow library). In such embodiments, workflow logic 120 may operate separately from or in a browser at computing device 1402, or may be configured in another way. As shown in FIG. 14, application 1404 may load workflow logic 120 for a selected workflow (e.g., selected from a workflow library by a user), and may execute workflow logic 120 to execute the workflow.

In another embodiment, a first portion of workflow logic 120 may execute in workflow application 1404 at computing device 1402 and a second portion of workflow logic 120 may execute in application execution engine 1418 at server 134 and/or elsewhere.

During execution of workflow logic 120, a push notification service may be invoked (e.g., by push notification execution engine 1430) for workflow step(s) for which a push notification connection is associated therewith. For example, upon execution of such a workflow step, computing device 1402 sends a request 1406 to transmit a push notification to server 134. Request 1406 may include one or more identifiers that identify one or more recipient(s) of the push notification, the message to be displayed for the push notification, and one or more parameters associated with the push notification (e.g., a parameter that indicates whether the target application associated with the push notification should be opened and/or behave in a certain manner upon receiving the push notification). Application execution engine 1418 may generate and transmit a push notification job 1408 corresponding to the request to queue(s) 1432 hosted on server 1414. Queue(s) 1432 may be configured to store push notification jobs originating from one or more source applications. Push notification execution engine 1430 may be configured to pull push notification jobs 1408 from queue(s) 1432 in the order specified by queue(s) 1432.

Push notification execution engine 1430 may be configured to determine the number of recipients that are to receive the push notification by determining the number of user identifiers that are associated with the push notification job. In the event that a group identifier is specified for the push notification job, push notification execution engine 1430 may provide a request 1416 to a directory service 1436 hosted on server 1422. Directory service 1436 may maintain a database that maps group identifiers to individual user identifiers (e.g., email addresses, phone numbers, etc.). Directory service 1436 may be configured to retrieve user identifiers that each uniquely identify a user included in the group identified by the group identifier. Directory service 1436 may provide one or more responses 1424 that include the determined user identifiers to push notification execution engine 1430. An example of directory service 1436 includes, but is not limited to the Azure Active Directory Graph service by Microsoft Corporation®.

Push notification execution engine 1430 may be configured to generate a push notification for each user identified by user identifier. Push notification execution engine 1430 may be configured to dynamically scale the amount of computing resources (e.g., processing power, memory, storage, network bandwidth, etc.) that are to be utilized when generating the push notifications. For example, in the event that the number of push notifications to be generated are relatively large (e.g., due to a large number of recipients), push notification execution engine 1430 may cause additional computing resources to be allocated. In the event that the number of push notifications to be generated are relatively small, push notification execution engine 1430 may not allocate an additional number and/or reduce the amount of computing resources to be utilized to generate the push notifications. In accordance with an embodiment, push notification execution engine 1430 may allocate one or more additional servers (not shown), virtual machines executing on server 1410 and/or virtual machines executing on other servers (not shown) to increase the amount of computing resources for push notification generation. Push notification execution engine 1430 may deallocate server(s), virtual machine(s) executing on sever(s) 1410 (and/or other server(s)) to reduce the amount of computing resources for push notification generation.

Transmission of the generated push notifications may be handled by a push notification service, such as Azure Notification Hubs from Microsoft Corporation®. For example, with reference to FIG. 14, network-based application(s) 124 may comprise a push notification service. Push notification execution engine 1430 may provide generated push notifications 1420 to network-based application(s) 124, which transmits the push notifications to users of the appropriate target application (e.g., target application 1428). For example, as shown in FIG. 14, network-based application(s) 124 transmits a push notification 1434 to target application 1428 executing on computing device 1412, which may be associated with a particular user identified by a user identifier determined by directory service 1036. In certain embodiments, recipients are not required to have the target application installed on their associated device to receive the push notification. Instead, recipients simply need to have the appropriate permission(s) to install the target application.

In accordance with an embodiment, application execution engine 1418 further comprises an authorization handler 1440. Authorization handler 1440 may be configured to determine whether a push notification is authorized to be transmitted to user(s) of a target application (e.g., target application 1428) in accordance with a policy rule associated with the connection used to transmit the push notification. The policy rule may specify which applications and/or users are authorized to transmit and/or receive push notifications. For example, authorization handler 1440 may determine whether the sender of the notification, the application sending the notification, whether any of the recipients specified by the push notification and/or whether the target application specified to receive the push notifications have permissions to send/receive push notifications. If authorization handler 1440 determines that the sender, receivers, source application and/or target application do not have permissions to transmit and/or receive push notifications, authorization handler 1440 denies (e.g., cancels) the push notification request (e.g., request 1406) provided by workflow application 1404. Thus, the receivers and/or target application will not receive the push notifications. This advantageously enables unauthorized push notifications (e.g., spam) to be rejected and not transmitted to users, thereby providing a secure channel for push notifications. It is noted that authorization handler 1440 may perform other validation schemes to determine whether or not a push notification is authorized to be transmitted. For example, authorization handler 1440 may further determine whether the specified recipient information is in a valid format (e.g., email address regular expressions), determine whether the provided recipient information exist in directory service 1436, etc.

The policy rule used by authorization handler 1440 may be configurable by an administrator via an administrative interface (e.g., administrative interface 1438). Additional details regarding administrative interface 1438 and the configuration of a policy rule is described below in Subsection E.

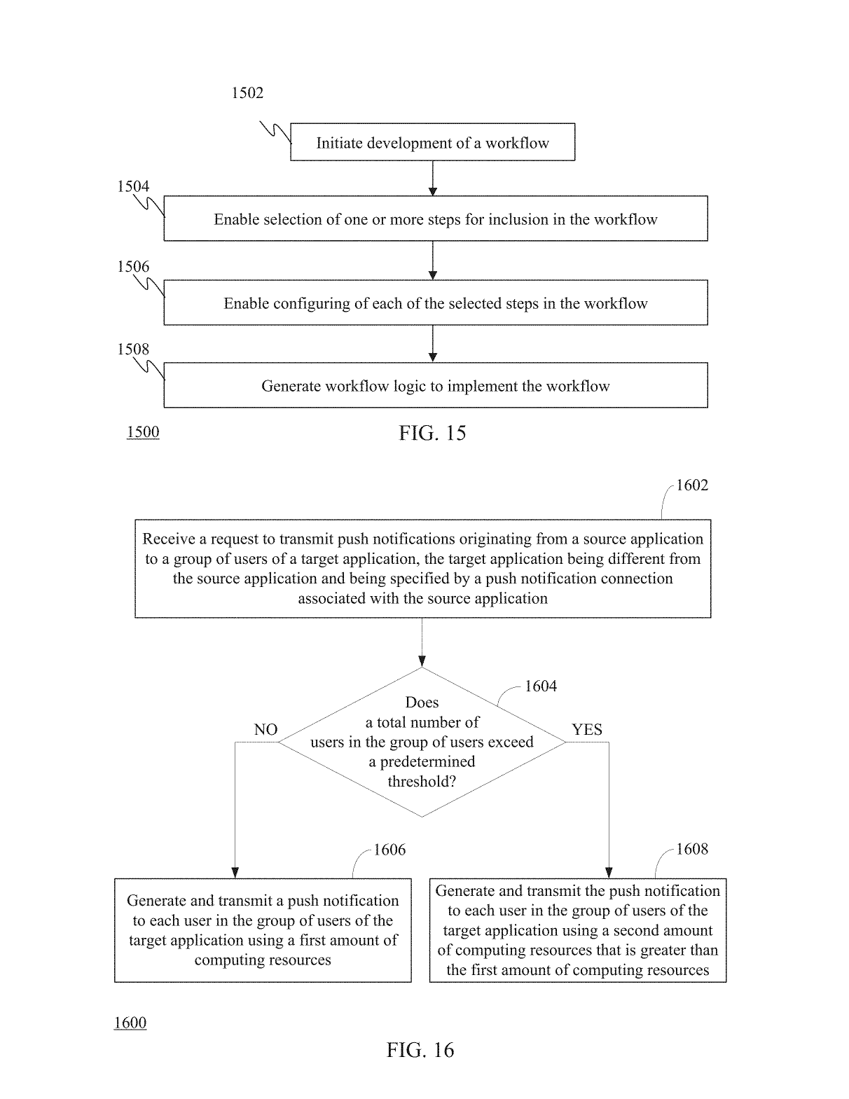

FIG. 15 shows a flowchart 1500 providing a process for executing workflow logic 120 of a workflow, according to an example embodiment. Flowchart 1500 is described as follows with respect to system 1400 of FIG. 14 for illustrative purposes.

Flowchart 1500 begins with step 1502. In step 1502, the workflow is executed. In an embodiment, an end user at computing device 1402 may cause workflow logic 120 to be executed, such as by command line, by clicking/tapping or otherwise interacting with an icon representing the application, by selection in a browser, or in another manner. As described above, workflow logic 120 may execute in workflow application 1404 at computing device 1402 and/or in application execution engine 1418 at server 134. When executed, the workflow steps of workflow logic 120 are performed in the configured sequence. Accordingly, one or more of the workflow steps may make calls to corresponding applications/services to perform their functions, such as local application 122 (to return data 132), network-based application(s) 124 (to return data 130, and/or other applications, local or network-based.

In step 1504, the workflow GUI is displayed. Step 1504 is optional, as in some embodiments, a GUI is not displayed for a workflow. In an embodiment, the GUI may be displayed by workflow application 1404 at computing device 1402. When displayed, the user may interact with the GUI by reviewing displayed data (e.g., from a file, database record, spreadsheet, or other data structure read by the workflow), by entering data into the GUI (e.g., by typing, by voice, etc.), and/or by interacting with one or more controls displayed by the GUI.

In step 1506, workflow logic is triggered based on an interaction with the workflow. Step 1506 is optional in cases where one or more workflow steps of a workflow require input from a user. In such cases, the user interacts with a control in a GUI of application 1404 associated with a workflow step of workflow logic 120 to provide information that triggers logic of the workflow step to operate.

In this manner, workflow logic 120 performs its functions, such as processing orders, tracking information, generating messages, processing documents to generate tasks or information, collecting feedback, and/or any other functions.

FIG. 16 shows a flowchart 1600 providing a process for generating and transmitting push notifications via a workflow application in accordance with an embodiment. Flowchart 1600 is described as follows with respect to system 1400 of FIG. 14 for illustrative purposes.

Flowchart 1600 begins with step 1602. In step 1602, a request is received from a source application to transmit push notifications originating from the source application to a group of users of a target application, the target application being different from the source application and being specified by a push notification connection associated with the source application. For example, with reference to FIG. 14, workflow application 1404 (i.e., a source application) transmits a request 1406 to transmit a push notification to target application 1428. Target application 1428 may be specified by a push notification connection associated with a particular workflow step of application 1404 (e.g., step 1204 shown in FIG. 12).

In step 1604, a determination is made as to whether a total number of users in the group of users exceeds a predetermined threshold. For example, with reference to FIG. 13, push notification execution engine 1430 may determine whether the total number of users in the group of users exceeds a predetermined threshold. If a determination is made that the total number of users in the group of users does not exceed the predetermined threshold, flow continues to step 1606. Otherwise, flow continues to step 1608.

In step 1606, a push notification is generated and transmitted to each user in the group of users of the target application using a first amount of computing resources. For example, with reference to FIG. 14, push notification execution engine 1430 may generate a push notification for each user in the group of users of target application 1428 and a push notification service (e.g., network-based application(s) 124) may transmit the push notifications to each user using a first amount of computing resources. For instance, push notification execution engine 1430 may determine that additional computing resources are not required to generate the push notifications and use the computing resources already allocated thereto (e.g., virtual machine(s) executing on server 1410 and/or virtual machine(s) executing on other server(s)).

In step 1608, a push notification is generated and transmitted to each user in the group of users of the target application using a second amount of computing resources that is greater than the first amount of computing resources. For example, with reference to FIG. 14, push notification execution engine 1430 may generate a push notification for each user in the group of users of target application 1428 and a push notification service (e.g., network-based application(s) 124) may transmit the push notifications to each user using a second amount of computing resources that is greater than the first amount of computing resources. For instance, push notification execution engine 1430 may determine that additional computing resources are required to generate the push notifications and allocate additional computing resources to perform push notification generation.

In accordance with one or more embodiments, the request specifies a group identifier representative of the group of users. In accordance with such an embodiment, a second request including the group identifier is provided to a directory service and a response from the directory service that includes a plurality of user identifiers, where each user identifier in the plurality of user identifiers uniquely represents a particular user in the group of users, is received. Each of the plurality of user identifiers is used to transmit the push notification to each user in the group of users of the target application. For example, with reference to FIG. 14, push notification execution engine 1430 provides request 1416 that includes the group identifier (e.g., a group email address) to directory service 1436. Directory service 1436 provides response 1420 that includes a plurality of user identifiers, where each user identifier in the plurality of user identifiers uniquely represents a particular user in the group of users.

E. Policy Rule Configuration Via an Administrative Interface

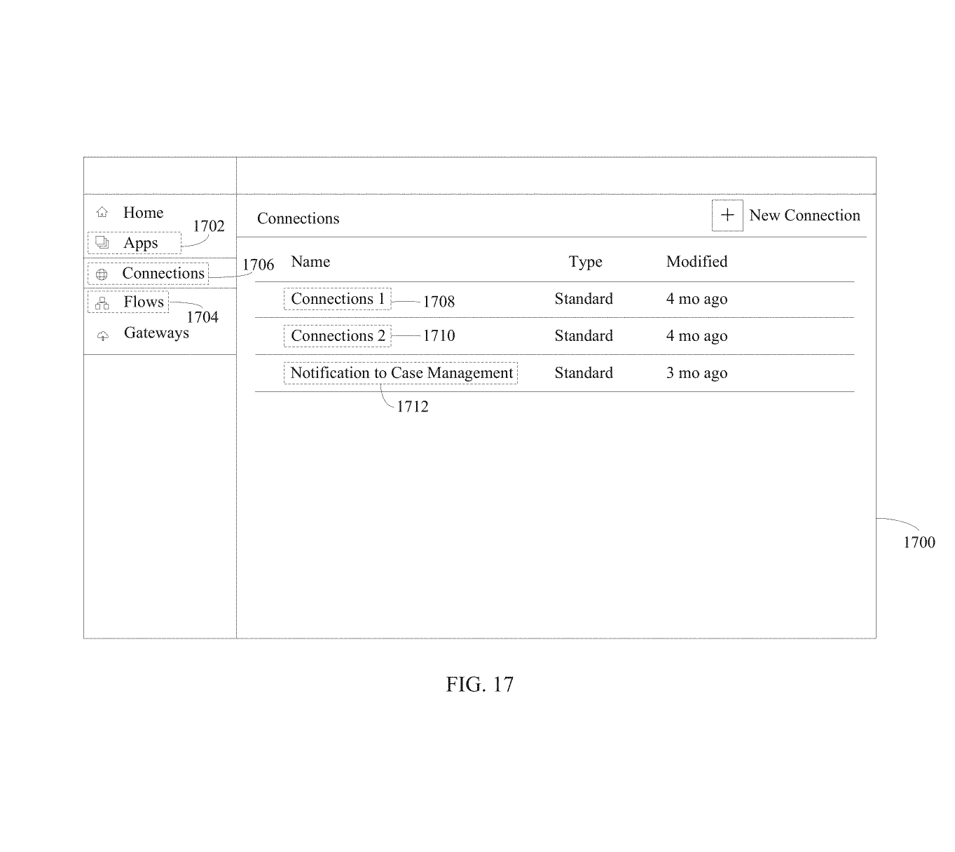

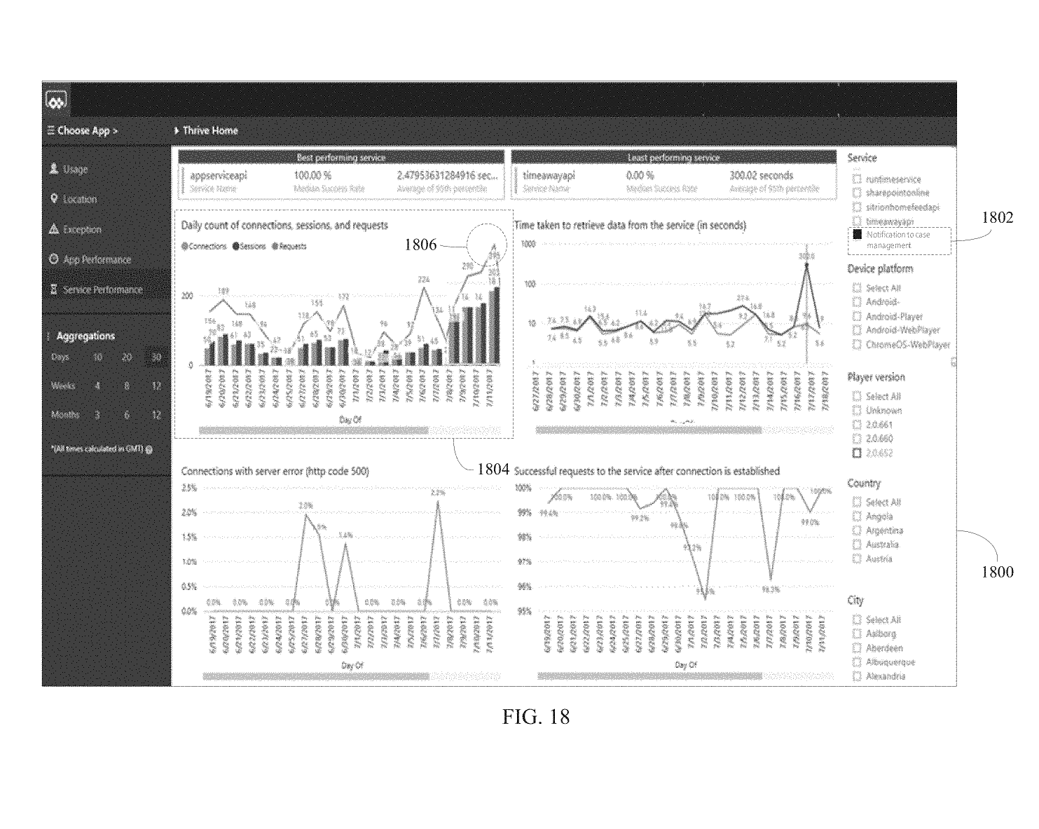

As described above, application designer 106 is configured to be operated/interacted with to create applications (e.g., business application(s), workflow application(s), etc.). Application designer 106 may further enable an administrator to configure one or more policy rules to be used when transmitting push notifications originating from workflow application 1404 and/or other applications via administrative interface 1438. UI generator 110 may transmit application GUI information 140 to a browser of server 1426 to be displayed as administrative interface 1438. FIGS. 17-20 show views of an exemplary administrative interface in accordance with an embodiment.

For instance, FIG. 17 shows an example GUI screen 1700 of administrative interface 1438 in accordance with an embodiment. As shown in FIG. 17, GUI screen 1700 includes a plurality of user-activatable interface elements, including, but not limited to, user interface element 1702, user interface element 1704 and user interface element 1706. User interface element 1702 (“Apps”), when activated by a user, may cause a GUI screen to be displayed that shows a listing of applications that are manageable by the administrator. User interface element 1704 (“Flows”), when activated by a user, may cause a GUI screen to be displayed that shows a listing of workflows that are manageable by the administrator. User interface 1706 (“Connections”), when activated by a user, may cause a GUI screen to be displayed that shows a listing of connections that are manageable by the administrator. As shown in FIG. 17, user interface 1706 has been activated by the user, thus a listing of user-selectable connection identifiers 1708, 1710, 1712 (i.e., “Connection 1,” “Connection 2,” and “Notification to Case Management”) are shown. The creation of the “Notification to Case Management” connection was described above in Subsection B. Each of “Connection 1”, “Connection 2”, and the “Notification to Case Management” connection may be associated with the same or different application.

FIG. 18 shows an example GUI screen 1800 of administrative interface 1438 in accordance with another embodiment. As shown in FIG. 18, administrative interface 1438 may enable the administrator to select a connection and monitor its performance (e.g., the amount of push notification requests associated with the selected connection). In the example shown in FIG. 18, the administrator has selected a user interface element 1802 corresponding to the “Notification to Case Management” connection. As further shown in FIG. 18, a portion 1806 of graph 1804 indicates that a high amount of push notification requests (e.g., 395) associated with the “Notification to Case Management” connection was transmitted on Jul. 11, 2017. GUI screen 1800 may also provide additional information associated with the selected connection. Such information may include, but is not limited to, the time it takes to retrieve data for the associated connection, the number of connection errors, the number of successful requests to a service after a connection is established, etc.

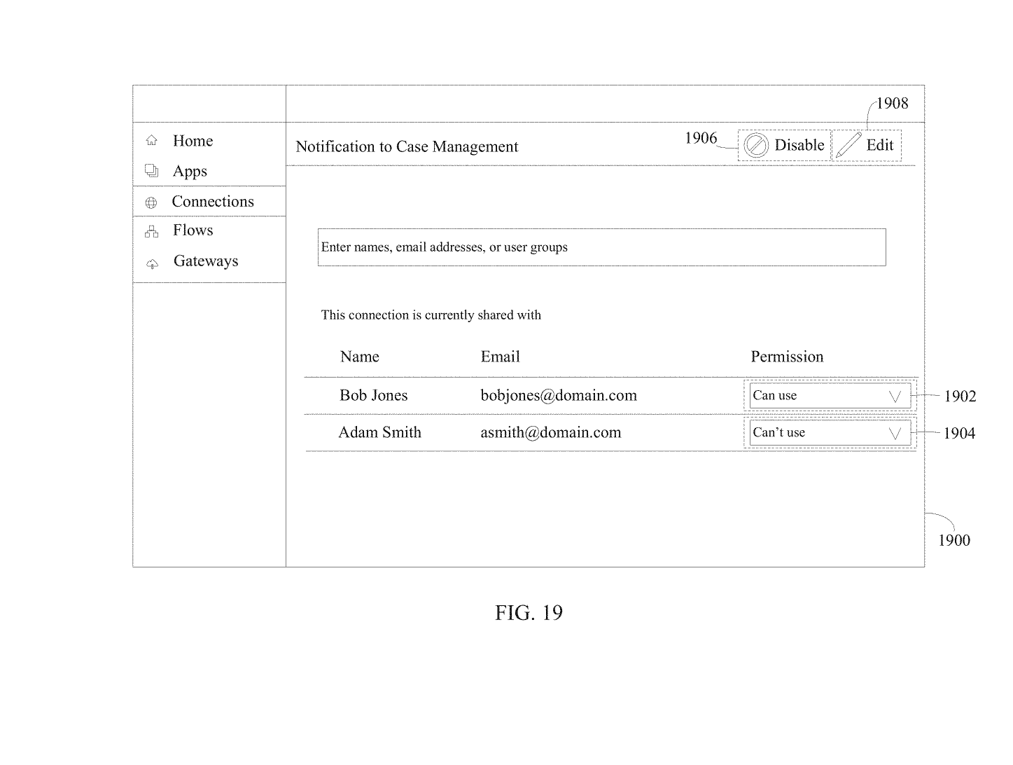

FIG. 19 shows an example GUI screen 1900 of administrative interface 1438 that enables a user to configure a policy rule associated with a connection in accordance with an embodiment. In the example shown in FIG. 19, the “Notification to Case Management” connection was selected (e.g., via connection identifier 1712) by the administrator. As shown in FIG. 19, a listing of users (e.g., “Bob Jones” and “Adam Smith”) that are enabled to use the “Notification to Case Management” connection for the transmission of push notification is shown. GUI screen 1900 may enable the administrator to designate whether each of the users are authorized to transmit push notifications via workflow application 1404. In the example shown in FIG. 19, a pull-down menu (e.g., a pull-down menu 1902 and a pull-down menu 1904) may be used to make the designation. For example, as shown in FIG. 19, pull-down menu 1902 is used to select the “Can use” option for user “Bob Jones”, and pull-down menu 1904 is used to select the “Can't use” option for user “Adam Smith.” Thus, user “Bob Jones” is enabled to transmit push notifications via the “Notification to case Management” connection, but user “Adam Smith” is not.

GUI screen 1900 may also include a user interface element 1906 and a user interface element 1908. User interface element 1906, when activated, disables all instances of the selected connection. By disabling the connection in this manner, all push notifications associated with the selected connection (regardless of the user associated therewith) are denied. User interface 1908, when activated, causes a GUI screen to be displayed that enables the administrator to modify the connection.

Administrative interface 1438 may enable an administrator to configure other policy rules. For example, administrative interface 1438 may enable an administrator to configure a policy rule for designating which recipients are enabled to receive certain push notifications, which target applications are enabled to receive certain push notifications, and/or which source applications are enabled to transmit certain push notifications.

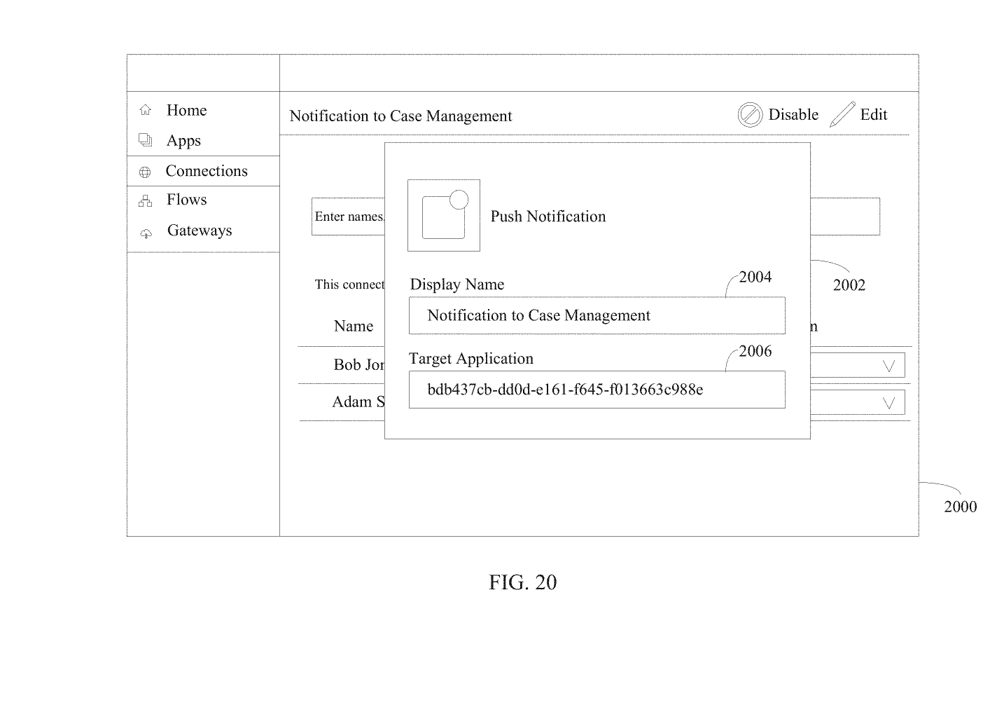

FIG. 20 shows an example GUI screen 2000 of administrative interface 1438 that enables a user to modify a connection in accordance with an embodiment. As shown in FIG. 20, upon activating user interface element 1908, the administrator is presented with a window 2002 that enables the user to modify certain parameters of the connection. For example, as shown in FIG. 20, window 1102 includes a user interactive field 2004 and a user interactive field 2006. User interactive field 2004 may enable the user to change the name of the connection, and user interactive field 2006 may enable the user to change the target application that is to receive push notifications via the connection by specifying the new target application name or a unique ID associated with the new target application.

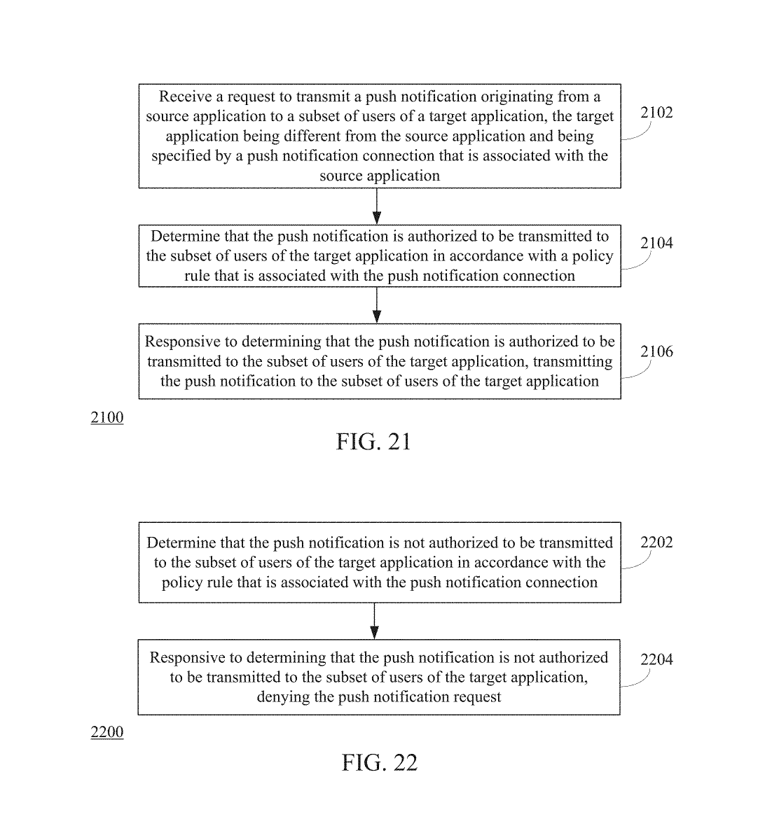

FIG. 21 shows a flowchart 2100 providing a process for transmitting push notifications in accordance with a policy rule in accordance with an embodiment. Flowchart 2100 is described as follows with respect to system 1400 of FIG. 14 for illustrative purposes.

Flowchart 2100 begins with step 2102. In step 2102, a request is received from a source application to transmit a push notification originating from the source application to a subset of users of a target application that is different than the source application, the target application being specified by a push notification connection associated with the source application. For example, with reference to FIG. 14, application 1404 (i.e., a source application) transmits a request 1406 to transmit a push notification to target application 1428. Target application 1428 may be specified by a push notification connection associated with a particular workflow step of application 1404 (e.g., step 1204 shown in FIG. 12).

In step 2104, a determination is made that the push notification is authorized to be transmitted to the subset of users of the target application in accordance with a policy rule that is associated with the push notification connection. For example, with reference to FIG. 14, authorization handler 1440 is configured to determine that the push notification is authorized to be transmitted to the subset of users of target application 1428 in accordance with a policy rule.

In accordance with one or more embodiments, the policy rule specifies one or more users of the source application are authorized to transmit push notifications.

In accordance with one or more embodiments, the policy rule is configurable by an administrator via an administrative interface. For example, with reference to FIG. 14, administrative interface 1438 enables an administrator to configure the policy rule.

In accordance with one or more embodiments, the administrative interface enables the administrator to configure a plurality of different policy rules, each of the different policy rules being associated with a different source application.

In accordance with one or more embodiments, an indication to update the policy rule to specify one or more users of the source application that are authorized to transmit push notifications originating from the source application is received by an administrator via an administrative interface. For example, with reference to FIG. 14, administrative interface 1438 may receive an indication to update the policy rule to specify users of the source application that are authorized to transmit push notifications.

In accordance with one or more embodiments, the developer specifies the target application for the push notification connection via a graphical user interface. For instance, GUI screen 1100 of FIG. 11 shows a developer specifying the target application for the “Notification to Case Management” connection.

In accordance with one or more embodiments, an indication to disable the push notification connection is received by an administrator via an administrative interface, and the push notification connection is disabled responsive to receiving the indication. The disabling of the push notification connection causes push notification requests received from the source application to be denied. For example, with reference to FIG. 14, administrative interface 1438 may receive an indication to disable the push notification connection by an administrator and administrative interface 1438 disables the push notification connection responsive to receiving the indication. For instance, with reference to GUI screen 1900 of FIG. 19, a user may disable the “Notification to Case Management” connection by interacting with user-interface element 1906. Application execution engine 1418 upon receiving a request to transmit a push notification (e.g., request 1406) may deny the request.

In accordance with one or more embodiments, an indication to change the target application specified by the push notification connection to a different target application is received by an administrator via an administrative interface and the target application specified by the push notification connection is changed to the different target application responsive to receiving the indication. The changing of the target application causes push notifications originating from the source application to be transmitted to the different target application. For example, with reference to FIG. 14, administrative interface 1438 may receive an indication to change the target application specified by the push notification connection to a different target application by an administrator, and administrative interface 1438 changes the target application specified by the push notification connection to the different target application responsive to receiving the indication. For instance, GUI screen 2000 of FIG. 20 shows an administrator changing the target application associated with the “Notification to Case Management” connection via user-interactive field 2006.

In step 2106 responsive to determining that the push notification is authorized to be transmitted to the subset of users of the target application, the push notification is transmitted to the subset of users of the target application. For example, with reference to FIG. 14, authorization handler 1440 may determine that the push notification is authorized to be transmitted to the subset of users of target application 1428, application execution engine 1418 sends request 1408 to transmit the push notification to queue(s) 1432, push notification execution engine 1430 pulls request 1408 from queue(s) 1432, push notification execution engine 1430 generates a push notification 1420 therefrom and provides push notification 1420 to a push notification service (e.g., network-based application(s) 124) for transmission to target application 1428.

FIG. 22 shows a flowchart 2200 providing a process for denying a push notification request in accordance with a policy rule in accordance with an embodiment. Flowchart 2200 is described as follows with respect to system 1400 of FIG. 14 for illustrative purposes.

In step 2202, a determination is made that the push notification is not authorized to be transmitted to the subset of users of the target application in accordance with the policy rule that is associated with the push notification connection. For example, with reference to FIG. 14, authorization handler 1440 is configured to determine that the push notification is not authorized to be transmitted to the subset of users of target application 1428 in accordance with a policy rule associated with the push notification connection.

In step 2204 responsive to determining that the push notification is not authorized to be transmitted to the subset of users of the target application, the push notification request is denied. For example, with reference to FIG. 14, authorization handler 1440 determines that the push notification is not authorized to be transmitted to the subset of users of target application 1428, and denies request 1408.

### III. Example Computer System Implementation

Computing device 102, application designer GUI 116, browser 136, server 134, application designer 106, UI generator 110, application logic generator 112, workflow library 118, storage 104, local application 122, network-based application(s) 124, application execution engine 1418, authorization handler 1440, server 1410, push notification execution engine 1430, server 1426, administrative interface 1438, computing device 1412, target application 1428, server 1422, directory service 1436, server 1414, queue(s) 1432, flowchart 200, flowchart 1500, flowchart 1600, flowchart 2100, and/or flowchart 2200 may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

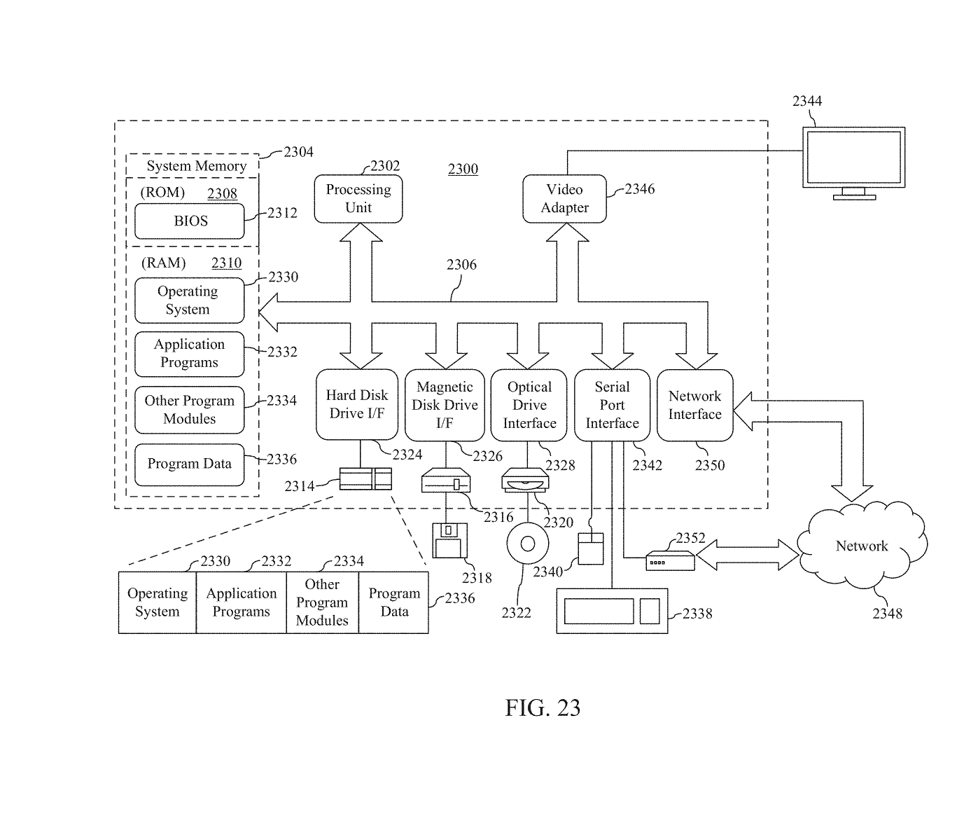

FIG. 23 depicts an exemplary implementation of a computing device 2300 in which embodiments may be implemented. For example, any of computing device 102, computing device 1412, server 134, server 1410, server 1414, server 1422, server 1426 may be implemented in one or more computing devices similar to computing device 2300 in stationary or mobile computer embodiments, including one or more features of computing device 2300 and/or alternative features. The description of computing device 2300 provided herein is provided for purposes of illustration, and is not intended to be limiting. Embodiments may be implemented in further types of computer systems, as would be known to persons skilled in the relevant art(s).

As shown in FIG. 23, computing device 2300 includes one or more processors, referred to as processor circuit 2302, a system memory 2304, and a bus 2306 that couples various system components including system memory 2304 to processor circuit 2302. Processor circuit 2302 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 2302 may execute program code stored in a computer readable medium, such as program code of operating system 2330, application programs 2332, other programs 2334, etc. Bus 2306 represents one or more of any of several types of bus structures, including a memory bus or memory controller, a peripheral bus, an accelerated graphics port, and a processor or local bus using any of a variety of bus architectures. System memory 2304 includes read only memory (ROM) 2308 and random access memory (RAM) 2310. A basic input/output system 2312 (BIOS) is stored in ROM 2308.

Computing device 2300 also has one or more of the following drives: a hard disk drive 2314 for reading from and writing to a hard disk, a magnetic disk drive 2316 for reading from or writing to a removable magnetic disk 2318, and an optical disk drive 2320 for reading from or writing to a removable optical disk 2322 such as a CD ROM, DVD ROM, or other optical media. Hard disk drive 2314, magnetic disk drive 2316, and optical disk drive 2320 are connected to bus 2306 by a hard disk drive interface 2324, a magnetic disk drive interface 2326, and an optical drive interface 2328, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 2330, one or more application programs 2332, other programs 2334, and program data 2336. Application programs 2332 or other programs 2334 may include, for example, computer program logic (e.g., computer program code or instructions) for implementing application designer 106, UI generator 110, application logic generator 112, workflow library 118, local application 122, network-based application(s) 124, workflow application 1404, application execution engine 1418, authorization handler 1440, administrative interface 1438, push notification execution engine 1430, target application 1428, directory service 1436, queue(s) 1432, flowchart 200, flowchart 1500, flowchart 1600, flowchart 2100, and/or flowchart 2200 (including any suitable steps thereof), and/or further embodiments described herein.

A user may enter commands and information into the computing device 2300 through input devices such as keyboard 2338 and pointing device 2340. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 2302 through a serial port interface 2342 that is coupled to bus 2306, but may be connected by other interfaces, such as a parallel port, game port, or a universal serial bus (USB).

A display screen 2344 is also connected to bus 2306 via an interface, such as a video adapter 2346. Display screen 2344 may be external to, or incorporated in computing device 2300. Display screen 2344 may display information, as well as being a user interface for receiving user commands and/or other information (e.g., by touch, finger gestures, virtual keyboard, etc.). In addition to display screen 2344, computing device 2300 may include other peripheral output devices (not shown) such as speakers and printers.

Computing device 2300 is connected to a network 2348 (e.g., the Internet) through an adaptor or network interface 2350, a modem 2352, or other means for establishing communications over the network. Modem 2352, which may be internal or external, may be connected to bus 2306 via serial port interface 2342, as shown in FIG. 23, or may be connected to bus 2306 using another interface type, including a parallel interface.

As used herein, the terms “computer program medium,” “computer-readable medium,” and “computer-readable storage medium” are used to refer to physical hardware media such as the hard disk associated with hard disk drive 2314, removable magnetic disk 2318, removable optical disk 2322, other physical hardware media such as RAMs, ROMs, flash memory cards, digital video disks, zip disks, MEMs, nanotechnology-based storage devices, and further types of physical/tangible hardware storage media (including memory 2320 of FIG. 23). Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 2332 and other programs 2334) may be stored on the hard disk, magnetic disk, optical disk, ROM, RAM, or other hardware storage medium. Such computer programs may also be received via network interface 2350, serial port interface 2342, or any other interface type. Such computer programs, when executed or loaded by an application, enable computing device 2300 to implement features of embodiments discussed herein. Accordingly, such computer programs represent controllers of the computing device 2300.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Example Embodiments

A method is described herein. The method includes: receiving a request to transmit a push notification originating from a source application to a subset of users of a target application that is different from the source application, the target application being different from the source application and being specified by a push notification connection that is associated with the source application; determining that the push notification is authorized to be transmitted to the subset of users of the target application in accordance with a policy rule that is associated with the push notification connection; and responsive to determining that the push notification is authorized to be transmitted to the subset of users of the target application, transmitting the push notification to the subset of users of the target application.

In one embodiment of the foregoing method, the policy rule specifies which users of the source application are authorized to transmit push notifications.

In another embodiment, the policy rule is configurable by an administrator via an administrative interface.

In yet another embodiment of the foregoing method, the administrative interface enables the administrator to configure a plurality of different policy rules, each of the different policy rules being associated with a different source application.

In a further embodiment of the foregoing method, the method further comprises receiving an indication to update the policy rule to specify one or more users of the source application that are authorized to transmit push notifications originating from the source application by an administrator via an administrative interface.

In yet another embodiment of the foregoing method, the method further comprises: determining that the push notification is not authorized to be transmitted to the subset of users of the target application in accordance with the policy rule that is associated with the push notification connection; and responsive to determining that the push notification is not authorized to be transmitted to the subset of users of the target application, denying the push notification request.

In still another embodiment of the foregoing method, a developer specifies the target application for the push notification connection via a graphical user interface.

In another embodiment of the foregoing method, the method further comprises receiving an indication to disable the push notification connection by an administrator via an administrative interface; and disabling the push notification connection responsive to receiving the indication, said disabling causing push notification requests received from the source application to be denied.

In yet another embodiment of the foregoing method, the method further comprises: receiving an indication to change the target application specified by the push notification connection to a different target application by an administrator via an administrative interface; and changing the target application specified by the push notification connection to the different target application responsive to receiving the indication, said changing causing push notifications originating from the source application to be transmitted to the different target application.

A system is also described herein. The system comprises one or more processors and one or more memories that store program code configured to be executed by the one or more processors, the program code, which, when executed by the at least one processor unit, causes the at least one processor circuit to perform operations, the operations comprising: receiving a request to transmit push notifications originating from a source application to a group of users of a target application, the target application being different from the source application and being specified by a push notification connection associated with the source application; and determining whether a total number of users in the group of users exceed a predetermined threshold; in response to determining that the total number of users in the group of users does not exceed the predetermined threshold: generating and transmitting a push notification to each user in the group of users of the target application using a first amount of computing resources; and in response to determining that the total number of users in the group of users exceeds the predetermined threshold: generating and transmitting the push notification to each user in the group of users of the target application using a second amount of computing resources that is greater than the first amount of computing resources.

In one embodiment of the foregoing system, the request specifies a group identifier representative of the group of users, and the one or more second servers are further configured to: submit a second request including the group identifier to a directory service; receive a response from the directory service that includes a plurality of user identifiers, each user identifier in the plurality of user identifiers uniquely representing a particular user in the group of users; and transmit the push notification to each user in the group of users of the target application using each of the plurality of user identifiers.

A computer-readable storage medium having program instructions recorded thereon that, when executed by at least one processing circuit, perform a method is also described herein. The method includes receiving a request to transmit a push notification originating from a source application to a subset of users of a target application that is different from the source application, the target application being specified by a push notification connection that is associated with the source application; determining that the push notification is authorized to be transmitted to the subset of users of the target application in accordance with a policy rule that is associated with the push notification connection; and responsive to determining that the push notification is authorized to be transmitted to the subset of users of the target application, transmitting the push notification to the subset of users of the target application.

In one embodiment of the foregoing method, the method further comprises: determining a total number of users in the subset of users; and based on the total number of users in the subset of users, determining an amount of computing resources to be used to transmit the push notification to the subset of users.

In another another embodiment of the foregoing method, the policy rule specifies one or more users of the source application are authorized to transmit push notifications.

In yet another embodiment, the policy rule being is configurable by an administrator via an administrative interface.

In a further embodiment of the foregoing method, the administrative interface enables the administrator to configure a plurality of different policy rules, each of the different policy rules being associated with a different source application.

In yet another embodiment of the foregoing method, the method further comprises: determining that the push notification is not authorized to be transmitted to the subset of users of the target application in accordance with the policy rule that is associated with the connection; and responsive to determining that the push notification is not authorized to be transmitted to the subset of users of the target application, denying the push notification request.

In still another embodiment of the foregoing method, a developer specifies the target application for the push notification connection via a graphical user interface.

In another embodiment of the foregoing method, the method further comprises receiving an indication to disable the push notification connection by an administrator via an administrative interface; and disabling the push notification connection responsive to receiving the indication, said disabling causing push notification requests received from the source application to be denied.

In yet another embodiment of the foregoing method, the method further comprises: receiving an indication to change the target application specified by the push notification connection to a different target application by an administrator via an administrative interface; and changing the target application specified by the push notification connection to the different target application responsive to receiving the indication, said changing causing push notifications originating from the source application to be transmitted to the different target application.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

1. A method, comprising:
receiving a request to transmit a push notification originating from a source application to a subset of users of a target application, the target application being different from the source application and being specified by a push notification connection that is associated with the source application;
determining that the push notification is authorized to be transmitted to the subset of users of the target application in accordance with a policy rule that is associated with the push notification connection; and
responsive to determining that the push notification is authorized to be transmitted to the subset of users of the target application, transmitting the push notification to the subset of users of the target application.

2. The method of claim 1, wherein the policy rule specifies one or more users of the source application are authorized to transmit push notifications.

3. The method of claim 1, wherein the policy rule is configurable by an administrator via an administrative interface.

4. The method of claim 3, wherein the administrative interface enables the administrator to configure a plurality of different policy rules, each of the different policy rules being associated with a different source application.

5. The method of claim 1, further comprising receiving an indication to update the policy rule to specify one or more users of the source application that are authorized to transmit push notifications originating from the source application by an administrator via an administrative interface.

6. The method of claim 1, further comprising:
determining that the push notification is not authorized to be transmitted to the subset of users of the target application in accordance with the policy rule that is associated with the push notification connection; and
responsive to determining that the push notification is not authorized to be transmitted to the subset of users of the target application, denying the push notification request.

7. The method of claim 1, wherein a developer specifies the target application for the push notification connection via a graphical user interface.

8. The method of claim 1, further comprising:
receiving an indication to disable the push notification connection by an administrator via an administrative interface; and
disabling the push notification connection responsive to receiving the indication, said disabling causing push notification requests received from the source application to be denied.

9. The method of claim 1, further comprising:
receiving an indication to change the target application specified by the push notification connection to a different target application by an administrator via an administrative interface; and
changing the target application specified by the push notification connection to the different target application responsive to receiving the indication, said changing causing push notifications originating from the source application to be transmitted to the different target application.

10. A system, comprising:
one or more processors; and
one or more memories that store program code configured to be executed by the one or more processors, the program code, which, when executed by the at least one processor unit, causes the at least one processor circuit to perform operations, the operations comprising:
receiving a request to transmit push notifications originating from a source application to a group of users of a target application, the target application being different from the source application and being specified by a push notification connection associated with the source application; and
determining whether a total number of users in the group of users exceed a predetermined threshold;
in response to determining that the total number of users in the group of users does not exceed the predetermined threshold:
generating and transmitting a push notification to each user in the group of users of the target application using a first amount of computing resources; and
in response to determining that the total number of users in the group of users exceeds the predetermined threshold:
generating and transmitting the push notification to each user in the group of users of the target application using a second amount of computing resources that is greater than the first amount of computing resources.

11. The system of claim 10, wherein the request specifies a group identifier representative of the group of users, and wherein the one or more second servers are further configured to:
submit a second request including the group identifier to a directory service;
receive a response from the directory service that includes a plurality of user identifiers, each user identifier in the plurality of user identifiers uniquely representing a particular user in the group of users; and
transmit the push notification to each user in the group of users of the target application using each of the plurality of user identifiers.

12. A computer-readable storage medium having program instructions recorded thereon that, when executed by at least one processing circuit, perform a method, the method comprising:
receiving a request to transmit a push notification originating from a source application to a subset of users of a target application, the target application being different from the source application and being specified by a push notification connection that is associated with the source application;
determining that the push notification is authorized to be transmitted to the subset of users of the target application in accordance with a policy rule that is associated with the push notification connection; and
responsive to determining that the push notification is authorized to be transmitted to the subset of users of the target application, transmitting the push notification to the subset of users of the target application.

13. The computer-readable storage medium of claim 12, wherein the method further comprises:
determining a total number of users in the subset of users; and
based on the total number of users in the subset of users, determining an amount of computing resources to be used to transmit the push notification to the subset of users.

14. The computer-readable storage medium of claim 12, wherein the policy rule specifies one or more users of the source application are authorized to transmit push notifications.

15. The computer-readable storage medium of claim 14, wherein the policy rule is configurable by an administrator via an administrative interface.

16. The computer-readable storage medium of claim 15, wherein the administrative interface enables the administrator to configure a plurality of different policy rules, each of the different policy rules being associated with a different source application.

17. The computer-readable storage medium of claim 12, the method further comprising:
determining that the push notification is not authorized to be transmitted to the subset of users of the target application in accordance with the policy rule that is associated with the connection; and
responsive to determining that the push notification is not authorized to be transmitted to the subset of users of the target application, denying the push notification request.

18. The computer-readable storage medium of claim 12, wherein a developer specifies the target application for the push notification connection via a graphical user interface.

19. The computer-readable storage medium of claim 12, the method further comprising:
receiving an indication to disable the push notification connection by an administrator via an administrative interface; and
disabling the push notification connection responsive to receiving the indication, said disabling causing push notification requests received from the source application to be denied.

20. The computer-readable storage medium of claim 12, the further comprising:
receiving an indication to change the target application specified by the push notification connection to a different target application by an administrator via an administrative interface; and
changing the target application specified by the push notification connection to the different target application responsive to receiving the indication, said changing causing push notifications originating from the source application to be transmitted to the different target application.
